(19) United States
(12) Patent Application Publication
(10) Pub. No.: US 2002/0199203 A1
(43) Pub. Date: Dec. 26, 2002

(54) Switched digital video gateway

(76) Inventors: John Duffy, Hopewell Junction, NY (US); Kenneth A. Shulman, Livingston, NJ (US)

Correspondence Address: BANNER & WITCOFF LTD.,, ATTORNEYS FOR AT & T CORP, 1001 G STREET , N.W., ELEVENTH STREET, WASHINGTON, DC, 20001-4597, US

(21) Appl. No.: 09/859,675

(22) Filed: May 18, 2001

(51) Int. Cl. H04N 7/173; H04L 12/28; H04L 12/56

(52) U.S. Cl. 725/109; 725/110; 725/127; 370/395.52; 370/401

(57) ABSTRACT

Video gateway apparatus, according to the present invention, for interworking between an internet protocol video data network and an integrated services digital network comprises a outer operatively associated with the internet protocol video data network for outputting video and control data associated with a video call originating in the internet network, at least one gateway switch coupled to the router and operatively associated with the integrated services digital network for outputting video and control data associated with a video call originating in the integrated services digital network, and at least one gatekeeper operatively associated with the router and the at least one gateway switch for translating between video telephone numbers assigned within said integrated services digital network and internet protocol addresses associated with said internet protocol video data network.

### BACKGROUND OF THE INVENTION

1. Technical Field

The present invention relates to the field of switched digital video services in a combined internet and switched telecommunications network environment and, in particular, to providing a gateway or node and method of video call processing in such an environment permitting secure digital video communications services so that internet users may communicate with telecommunications network users and vice versa via the gateway.

2. Description of the Related Arts

Real time video conferencing technology is in a transition stage similar to that being experienced by voice technology. The current state of the video industry is one where the two leading video transport technologies are H.320, the Integrated Services Digital Network (ISDN) standard and H.323, the Internet Protocol (IP) standard. Although H.323 is rapidly improving, H.320 holds the overwhelming market and technical performance lead.

In the H.320 ISDN environment, AT&T Corporation has implemented a Global Integrated Services Digital Network (GISDN), which is a switched digital network for switched video traffic. This GISDN overlays the well known switched data network for data traffic which in turn is a subset of switched network services including voice traffic. The basic building blocks of the GISDN network are its switches, in particular, a network of tandem time division multiplex switches, each being typically a #4ESS time division multiplex switch available from Lucent Technologies, Inc. At a local level, closest to a subscriber, the basic building block of a local network is the #5ESS switch, also available from Lucent. To the #5ESS switch may be connected the local subscriber loop comprising, typically, a twisted copper pair of wires or a wireless, typically, cellular radio connection. Other switches available from other telecommunications suppliers are used for similar purposes in AT&T and other local and long distance ISDN networks.

The local subscriber loop has also enjoyed a personality change over recent years. Subscribers have been able to purchase ISDN service over their local loops but new technologies have brought the cost of bandwidth to the subscriber down. In hybrid fiber twisted pair loop and hybrid fiber coax, fiber to the curb and the like loop architectures, there has evolved an opportunity for increasing bandwidth to the subscriber, either home or business customer, for example for video services at lower cost than ISDN over twisted pair. The competing architectures have been described as digital subscriber line and cable modem technologies where in the former, the loop is shared by, for example, all members of a household, but one may be able to talk on the telephone and receive a video data stream at the same time. On the other hand, in the cable modem technology which enjoys higher bandwidth, for example, hundreds of megabits or gigabits versus T1 or 1.5 megabit data rates for DSL, the higher cable modem bandwidth is shared by all those sharing a common fiber to/from a central office.

In a wireless network, for example, cellular or direct satellite, radio frequency spectrum presently limits bandwidth for video applications. While downstream, toward the user, broadcast services are economically permitted and competitive, upstream, for example, video telephony services have not grown as rapidly as wired video services. One wireless technology known as free space optical communication via modulated laser light shows promise for expanding the available wireless bandwidth in congested metropolitan areas. A new standard known as Bluetooth shows promise for short distance, high bit rate wireless connections for mobile personal computers equipped with cameras and displays.

On the other hand from conventional H.320 ISDN switched data services, H.323, the IP standard, has brought about a network built around packet data. There exists a general evolution, for example, toward Asynchronous Transfer Mode (ATM) as a backbone network and toward frame and cell relay services. Consequently while H.320 video is a standard switched video technology, the growth of Internet video must be accounted for. Both H.320 and H.323 services may be accessed by the local subscriber using available and predicted technology. Thus, there exists a trend towards a wide deployment and acceptance of Internet Protocol (IP) based data networks, rapidly dropping prices of video endpoints (video clients), a migration of video units from a hardware based to a software based deployment and a wide range of new video features made available by applying IP technology.

Consequently, there is a need in the art to provide an interface between a legacy ISDN standard H.320 video switched data network and a packet-based H.323 Internet Protocol based network.

### SUMMARY OF THE INVENTION

The problems and related inability of an H.320 video subscriber to communicate with an H.323 video service user or vice versa or for H.323 video subscribers to securely communicate and be billed for video services is overcome via the principles of the present invention, a Video Gateway Node, referred to herein as a Switched Digital Video Gateway or simply video gateway. The Switched Digital Video Gateway (SDVG) bridges the gap between competing video technologies while simultaneously enabling customers to enjoy the advantages of such video technologies as they improve. The video gateway of the present invention will have a network based service architecture with features including but not limited to serving as a gateway node between IP and ISDN based video systems, providing integrated billing between ISDN and IP based networks, providing directory views which show users the status (busy/idle/capability) of another subscriber's endpoints (similar to an instant message environment), and providing access technology independence, IP and H.320 multi-point conferencing options, H.323 security from pirates and quality of service QoS connectivity.

Video gateway apparatus, according to the present invention, for interworking between an internet protocol video data network and an integrated services digital network comprises at least one router operatively associated with the internet protocol video data network for outputting video and control data associated with a video call originating in the internet network, at least one gateway coupled to the router and operatively associated with the integrated services digital network for outputting video and control data associated with a video call originating in the integrated services digital network, and at least one gatekeeper operatively associated with the router and the gateway for translating between video telephone numbers assigned within the integrated services digital network and internet protocol addresses associated with the internet protocol video data network. In connection with completing a video call terminating in the ISDN, a feature of the present invention is a pushing or data transmission of a calling party identification, for example, the translated calling party telephone number from their internet address, into the ISDN network via a primary rate interface channel.

A method of processing a video call via video gateway apparatus originating in an internet protocol video data network for completion within an integrated services digital network comprises the steps of receiving an address formatted as an internet address representing an integrated services digital network telephone number and translating the address into video data routing data, the video gateway apparatus for delivering received packetized video data to a video capable telephone associated with the integrated services digital network telephone number.

A method of processing a video call via video gateway apparatus originating in an integrated services digital network for completion within an internet protocol video data network comprises the steps of receiving an address formatted as a local telephone number representing an internet address and translating the received address into a destination internet address associated with the local telephone number, the video gateway routing video data associated with the video call to said destination internet address.

A method of assuring security of a video call in an internet protocol video data network wherein a router communicates with a gatekeeper of the network in a control channel session is characterized by the steps of the router initiating a query of the gatekeeper to determine the status of the control channel session and the router precluding a delivery of video data to a destination address if the query is negative or the router delivering video data to a destination address if the query is positive.

These and other features of the present invention will be better understood with reference to the drawings and the detailed description of a preferred embodiment.

### BRIEF DESCRIPTION OF THE DRAWINGS

FIG. 1 is a simplified schematic block diagram of a network architecture according to the present invention whereby an H.320 video user is shown communicating with an H.323 video user via a switched digital video gateway (SDVG) 140 according to the present invention. A conventional H.320 Primary Rate Interface channel interface is shown coupling an H.320 switched data network with the gateway on the one hand and H.323 Permanent Virtual Circuits (PVC) or H.321 means for coupling an asynchronous transfer mode (ATM) network on the other hand providing ATM Quality of Service (QOS).

FIG. 2 is a detailed schematic block diagram showing individual components of the architecture of FIG. 1 wherein the video gateway 140 of FIG. 1 is shown comprising at least or router for routing a number of H.323 video calls at rates of tens to hundreds of megabits of H.321 video calls via at least one H.323 gatekeeper and at least one, typically, a plurality of gateways having at least one gateway switch for H.321 video calls and furthermore showing individual facilities and components such as an SDSL loop connecting a toll carrier (such as AT&T) to an exemplary H.323 video client and Basic Rate Interface channels connecting a local exchange carrier or a primary rate interface channel (PRI) connecting a toll carrier to an exemplary H.320 video client.

FIG. 3 is a simplified block diagram showing operation of the router 205 of FIG. 2 for securing video services between H.323 video clients from theft of service whereby the router separately queries the gatekeeper to assure that an H.323 control channel session is in progress, directly or via a radius server, otherwise, the video packets may not be routed.

### DETAILED DESCRIPTION OF THE INVENTION

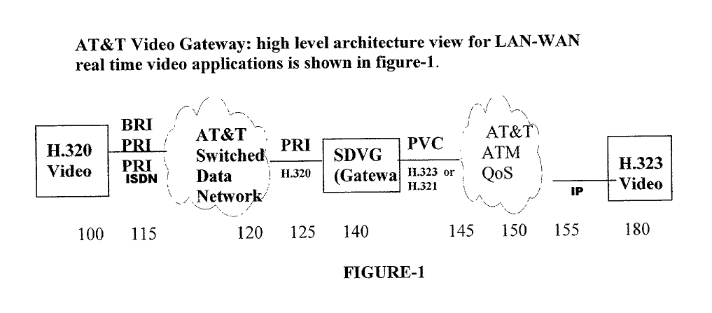

Referring to FIG. 1, a Video Gateway 140 according to the present invention is shown intended to comprise a value-added nodal service gateway between existing video clients 100 supported currently by a legacy circuit switched network 120 having ISDN-access, as well as, existing and future video-clients 180 to be connected over supported Digital Subscriber Line (DSL)/IP/ATM/Frame Relay (FR) or other subscriber access-technologies known in the art. Other technologies that come to mind and should be included within the scope of the present invention should be considered to include cable modem technologies, Bluetooth wireless standard and free space optical link technologies and associated facilities known in the art. The invention will be described in the context of an implementation undertaken by AT&T Corporation but is not to be deemed to be limited by the particular implementation by AT&T described herein. Alternative subscriber equipment, router equipment, gateway switch, gateway, gatekeeper and the like equipment is either presently known or under development that may be configured in alternative ways without departing from the scope of the claimed invention. While an Ethernet hub is utilized to couple and permit communications among the various components of the Node 104, other local or even wide-area data network means maybe used for similar purposes. Furthermore, while a glossary of acronyms and terms are provided herein, the reader is referred to Newton's Telecom Dictionary, 17th edition, for further explanation of terms used herein. Similar reference numerals will identify similar elements within the drawings. The first numeral of a reference numeral such as the most significant digit one of the reference numeral 140 representing an SDVG represents that SDVG first appears in FIG. 1.

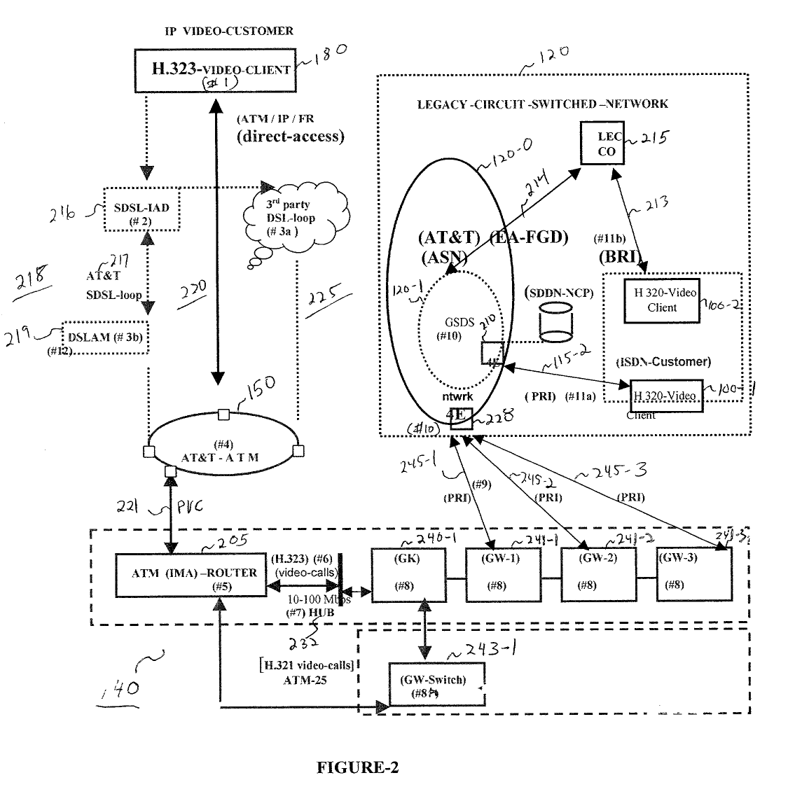

The legacy switched digital network 120 (depicted as the AT&T Switched Data Network as an example) may most conveniently access gateway 140 via custom primary rate interface (PRI) channels 125. In a terminating video call within the legacy network 120, the PRI 125 may be used to push the identity of the calling H.323 video client into the legacy network as will be further described herein. ATM network 150 may most conveniently access gateway 140 via permanent virtual circuits (PVC) 145 but other facilities such as IP enabled ports may come to mind of one ordinary skilled in the art as an alternative. Call flows and services delivered over the Video Gateway nodes, to be further described with reference to FIG. 2 depicting Gateway (GW), Gatekeeper (GK), and Gateway-Router components, can vary depending on how the Video Gateway 140 offers will be priced, provisioned and supported for different customers and different applications.

As can be seen from brief reference to FIG. 2 and as Video Gateway nodes 140 can accept end-to-end video-calls, the core-network-backbone supporting such Video Gateway nodes practically extends all the way to a customer premises depending on the customers' choice for broadband access (i.e., DSL, ATM, ISDN, Bluetooth, free space optics etc.)

Video Gateway—Architecture

Referring again to FIG. 1 as an overview to the AT&T implementation, Video Gateway 140 is a nodal service gateway intended to provide seamless connectivity between H.320 (ISDN) video-clients 100 reaching the video gateway 140 through the legacy circuit switched network, typically but not limited to time division multiplex (TDM) network 120 via ISDN-access, and, H.323 or H.321 video-clients 180 reaching the gateway 140 through IP/ATM network(s) via a SDSL (a special form of DSL to be discussed further herein), ATM, IP enabled ports or Frame Relay (FR) or other known access. The purpose of the Video Gateway 140 is to provide supplemental SDSL access and/or broadband IP/ATM/FR-access for real time video applications, real time video-conferencing, and, point-to-multi-point digital video-connectivity between the legacy TDM network 120 and newer IP/ATM/FR networks 150. National and international video calls are supported via geographically dispersed ISDN gatekeepers according to H.323 international standards.

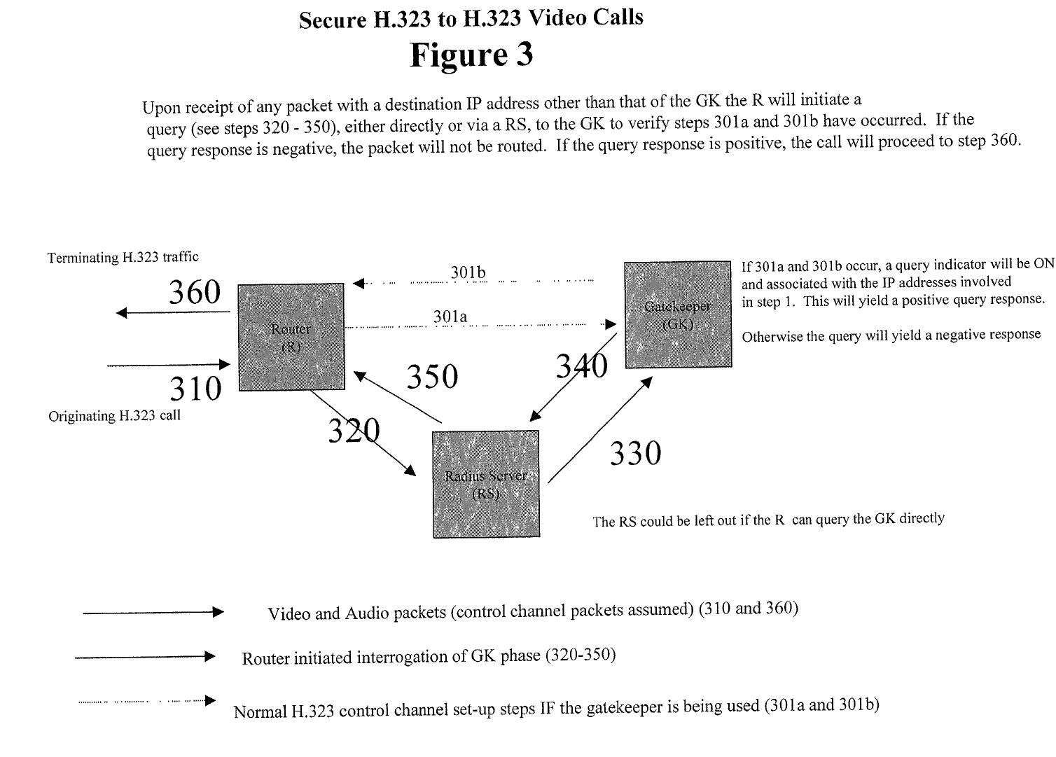

Referring now to FIG. 2, a convention followed already in FIG. 1, in this figure and in FIG. 3 is that the most significant numeral of a reference number refers to the first time an element appears in a drawing, for example, edge switch 210 first appears in FIG. 2. A plurality of H.320 (ISDN) video-clients 100-1 and 100-2 of which only two are shown, for example, served by AT&T, connect to AT&T's Global Switched Digital Services (GSDS) network 120-1 {a wide-band subset of an AT&T Switched Network (ASN) 120-0} or may connect to networks of other long distance carriers to transmit real time video-applications over custom PRI-access 115-2 provided, for example, by AT&T between customer premises 100-1 and a 4ESS-switch 210 capable of supporting such access. Binary NSF features are built into custom-PRI (23B+1D) access 115-2. This enables the billing of video calls as n×64 or 384 kbps video-calls with Calling Party Number (CPN) or automatic number identification (ANI) passing over the D-channel of PRI-trunks homed in data-domain (domain-82) of 4ESS switch 210. Wide-band inter-toll trunks required for n×64C, bonded H-0 (384) or H-11 (1536) tariff rated calls are seized between GSDS-points of presence (POPs) on the ASN 120-0 for digital video transport. Other higher bit rate video calls may be supported in time as demand or technology permits.

The existent GSDS network 120-1 also supports a plurality of BRI-clients 100-2, of which only one is shown, via BRI channels 213, of which only one is shown, of Regional Bell Operating Companies (RBOC) or other local exchange carriers (LEC) 215 that provide, for example, narrow-band (2B+1D) ISDN-video at 128 kbps. BRI-client initiated calls are switched on to GSDS-POPs of the ASN 120-0 via Feature Group-D (FG-D) trunks 214 that provide equal access between RBOC or LEC Central Offices (COs) 215 of which only one is shown and the ASN 120-0. National ISDN (NI-2) network development (with parameterized NSF-features) carries H.320 (ISDN) calls over National ISDN (NI) PRI-access provided by LECs 215. National ISDN-PRI trunks are supported by AT&T. NI-2 (National ISDN 2) trunks can also be provisioned between an edge switch (e.g., 5ESS, DMS2) such as switch 210 and an AT&T core switch (e.g., 4ESS) such as switch 228 to generate billable automatic message accounting AMA-records for ISDN calls, and up-chained H.320 (ISDN) video-calls over NI-2 trunks. This provisioning supports seamless transport of H.320 (ISDN) video-applications over National ISDN-2 (NI-2) trunks.

To carry interactive video that is virtually jitter-free over IP/ATM network 150, Constant Bit Rate (CBR) access to an H.323 (IP) and/or H.321 (ATM) enabled packet-network 150 is required. Therefore, the depicted access media 218, 220, 225 supports the best levels of Quality of Service (QoS). Towards that end, ATM, SDSL (a type of DSL which utilizes ATM), Frame Relay (FR) and IP (both of which are migrating to QoS architectures) are shown in FIG. 2.

On the other hand Q.931 & ISUP protocols may be utilized as the client-access-protocol for H.320 (ISDN) enabled video-clients 100-1 and 100-2 switched over the present Public Switched Telephone Network (PSTN) 120 or via direct access over PRI-circuits 115-2. Core and Edge-switch feature developments to provide National ISDN (NI-2) connectivity with in-built parameterized NSF-features support video applications of clients using NI-2 access.

By reference numeral 218 is intended an SDSL connection provided by AT&T, by numeral 220, a direct ATM connection and by 225 a DSL loop provided by a third party. Other internet access technologies not shown but which should be deemed to be included within the scope of the present invention include free space optical links, Bluetooth, H.321 and cable modem via hybrid fiber coax or other known facility between H.323 or H.321 video client and ATM 150 and gateway 140.

Multiple client-calls to the ATM/IP end 150 of the Video Gateway 140 of the present invention will be integrated using Access Routers 205, to be further described herein or an H.321 switch. Simultaneous calls from multiple new video clients 180 can be aggregated and carried over large Permanent Virtual Circuit (PVC) pipes 221 (FIG. 2, bold arrow to/from ATM network 150 and router 205). Other technologies such as virtual IP port access may be used as a matter of design choice.

In accordance with the present invention, SDVG 140 comprises at least one router 205, at least one gatekeeper 240-1, at least one gateway 241-1 having an associated at least one switch 243-1 for example, as may be rebuilt for H.321 clients. Now typical calls, starting with an international call, will be described with reference to FIGS. 1 and 2.

AT&T Video Gateway—International Calls

H.320 (ISDN) video-customers 100-1, 100-2 (FIG. 1) connecting to International video-client locations via the GSDS network 120-1 may launch/receive video-calls to/from USA based DSL subscribers &/or direct ATM/IP subscribers 180 of AT&T or other service provider Video Gateway-nodes 140 according to the present invention. International/national clients 100 may verify AT&T Video Gateway-functionality via calls to selected (targeted) countries by their country and city codes. Targeted countries (& International-clients) may be selected from present SDDN-I customers using n×64 or 384 video-services. Also, all such Outgoing International calls may be made to end-points previously tested for ISUP-services, using loop-back numbers (where available) of International Telecom Administrations (ITA.)

USA-subscribers using direct IP/ATM access to reach AT&T Video Gateway-nodes 140, and, USA-subscribers using DSL-access and other access as available may launch video-calls to subscribers overseas presently using the AT&T GSDS (SDDN/SDS/SDI) network 120-1. In such International calling scenarios, the subscriber will specify the International dialing number consisting of the Country Code (CC)+the in-country regional numbering-scheme of the call destination country. The Country Codes (CC) can typically be extended 2 to 3 digits except for World Zone-1 countries. [World Zone-1 that includes U.S.A, Canada and the Caribbean have the single digit country code of 1.] The in-country regional numbering schemes overseas vary widely, with some countries using city codes (area codes) that have fixed digit length for various geographical locations and cities within that country to countries that use variable number digits for designating their city codes. Examples of countries with a fixed number of digits for their city codes (area codes) include Morocco with a single digit area code, and the World Zone 1 (like the USA) countries with 3-digit area codes. As for non-fixed city code (area code) countries, exemplary nation French and Mexican city codes range from 1 to 3 digits. The latter scheme is more dominant in the international arena. As for the in-country line numbers, the number of digits constituting the subscriber line number can range from 4 to 7 depending on the country. The number of digits, including country code, city code, and, subscriber line number that must be dialed to reach a customer overseas can range from 8 to 12.

In addition, to indicate that the call is International (for proper billing), an International call designator (code) must be included in the United States in the initial addressing required for setting up the outgoing International call.

In International video-calls that are routed to AT&T Video Gateway-node 140, the initial call setup protocol results in packets being routed over the IP/ATM backbone 150 and forwarded to the appropriate Gate Keeper 240-1 and gateway 241-1, 241-2 or 241-3 of AT&T Video Gateway node 140 for switching via switch 243-1 as necessary. PRI-trunks 245-1, 245-2, 245-3 homed at the AT&T Video Gateway-nodes 140 will carry Outgoing international video-calls that are routed to International Switching Centers (ISCs), not shown. International Switching Centers (ISCs) must also set the International call indicator(s) (such as 011 in the USA). The bearer may be specified as 64 kbps un-restricted. Billing record(s) for International outgoing calls are generated using Calling Party Numbers (CPN) passed from video-clients accessing Video Gateway 140.

Billing records retrieval processes for International (outgoing) video-calls made by USA based DSL-customers, ATM and/or FR customers via AT&T Video Gateway-node(s) 140 may be handled according to processes known in the art for outgoing International video-calls.

AT&T Video Gateway/Gatekeeper (GW/GK) elements 240-1 and 241-1, 241-2 and 241-3 may handle call address translation, call admission control based on 8 to 12 digit dial-plans associated with International (outgoing) video-calls. AT&T Video Gateway functions, such as, Call Signaling, Call Authorization, and Call Management may be extended to International (outgoing) calls.

The call set-up delay due to extended digit processing will not result in “time-out” of call-initiating video-codec equipment (customer premises equipment, CPE). Also, call set up and call progress protocol exchange between the far end CPE (to be in ON-state always) and the video-codec-equipment (CPE) of video-subscribers does not result in call-setup timer expiration.

International callers using packet-based access are able to make video calls to other subscribers who are also using packet-based access over Video Gateway-nodes 140. Although, initially both subscribers may be most likely in the U.S.A, the architecture of FIG. 2 allows for calls between U.S.A and overseas locations. It is possible to route the call over the IP backbone network 150. The dialing may be based upon E.164 address formats.

International incoming call flow will be identical to the domestic incoming call flow as it relates to Video Gateway services. All International calls are handled as they would normally be handled by the GISDN network and then passed on to AT&T Video Gateway-nodes 140 via Gateway-homed PRIs 245.

Video Gateway Architecture

A high level view of AT&T Video Gateway 140 is shown in FIG. 2. AT&T Video Gateway nodal-elements are indicated within two dashed-line box (es). LAN-WAN inter-networking of IP-system-entities, such as, Gateway (GW), Gatekeeper (GK) and IP-Router 205 from approved vendor(s) are possible via a hub such as an Ethernet hub. Consequently, it is not beyond the scope of the present invention, for example, for router 205 to be interconnected with switch 243-1 or gatekeeper 240-1 that are physically in remote locations and not positioned closely together, for example, within the same equipment building. An objective is to mix and match the different vendor systems providing various elements such as router 205, gatekeeper 240, gateway 241 or switch 243 and yet assure interoperability between vendor systems. For example, under consideration are gatekeeper/router joint functionality, gateway/switch pairs or gatekeeper/gateway pairs or, in other words, the intermingling of functionality and capacities and limitations of transmission distances to provide greater service efficiency.

In one embodiment, Client (Customer) video-codec (equipment) is mapped to IP-Addresses and pre-assigned VPI/VCI identifiers of Permanent Virtual Circuits (PVCs) that connect AT&T Video Gateway 140 with an AT&M or FR switch network 150. The task of setting up the Network Access end-points is the responsibility of the customer. Enabling the PVC(s) 221 is part of provisioning functions performed by the toll network, such as AT&T, and is required to be done prior to a launching of AT&T Video Gateway directed calls by a client (customer) 180. Clients 180 may be assigned alias identifier(s) to be used with H.323-video-calls. The alias identifier(s) assigned will point to the North American Number Plan (NANP) compliant 10-digit dialed number (NANPN) to be connected at the far-end. Customers will be required to set up the video-client(s) used at their premises prior to video call launch.

Some example(s) of alias identifiers are: ALIAS=700 # * (e.g., 700-569-XXXX for SDDN call-types, and, 700-568-XXXX for SDS call-types) and Gatekeeper (GK)=IP Address of Gateway (GW) node, Gatekeeper, and, sub-net mask of Gateway node.

AT&T assigned 700 numbers may be referred to herein as Video Telephone Numbers (VTN's). Also, specifics of Client-End-Provisioning can differ depending on the type of QoS controls enforced, the ACCESS-NETWORK, and the type of DSL/IP/ATM or other access selected by individual clients 180 to reach AT&T Video Gateway-nodes 140. {Note: Client-end video-codecs typically use proprietary data-link-layer (OSI layer-2) protocol-stacks. Individual video-clients may use proprietary GUI-based call-launch sequences built into their video-codecs.}

In AT&T's Video Gateway 140, AT&T intend to only use routing-configurations via router 205 to connect to video end-points. Bridging as an alternative to routing is not presently anticipated but may be supported in the future.

Video-call specific PVC-identifiers (VPI/VCI values) are assigned (by AT&T on direct ATM-connections, and/or, by the DSL-access provider when third party DSL-access is used) to a PVC 221 that will be provisioned by AT&T from: either a) the customer-port on the AT&T-ATM network 150 or b) to the ATM-port serving as the “gateway” to a DSL-access provider network. These PVCs can be constant bit rate CBR or variable bit rate (VBRrt) (Real Time VBR) depending on availability. PVCs 221 will typically be built for a data-rate of minimum 512 kbps from/to a customer-port that other rates may be supported.

Switched Digital Video Gatekeeper (GK) 240, of which only one is shown, correlates, sometimes referred to herein as translating, pre-assigned client (customer) alias (700#) with a customer specific IP-Address (the customer being the assignee of the aforementioned 700#). IP-Address selection depends on the type and mix of applications selected by the AT&T Video Gateway-subscriber. IP-address selection can vary on a case-by-case basis.

A router 205 provisioning/maintenance work-center may co-ordinate with an AT&T Video Gateway-node 140 provisioning/maintenance work-center to correlate customer (client) specific IP-address(s) and related VPI/VCI-assignments for video-specific calls.

Call Flows

FIG. 2 shows call-flow-stage # referenced in (parenthesis) such as #1, #2, #3 and so on as well as the identity of the involved element is provided by a separate reference numeral (H.323 video client 180, SDSL-IAD 216, respectively). Again, the following description refers to call flow in an AT&T network used by way of example, the invention not to be deemed to be limited thereto.

Outgoing Video Calls [H.323 (Originating) to H.320 (Terminating)]

From a compatible video-CPE (codec), the client (customer) 180 (#1) may select an H.323 video software-icon (module) on a display screen, not shown, and enter the destination NANPN [for example, 10-digit phone # {700 # (VTN)] to be connected. The video-call type (n×64 kbps or 384 kbps) is also selected by the call originating-client (customer) by using an appropriate Graphic User Interface (GUI) (not shown) and end-point software used for call-launch at the video-client-end 180. Examples of H.323 client hardware will be identified subsequently herein. Using ALIAS=700# (VTN) logic, and, GK=IP-Address logic (previously set-up using information provided by AT&T) H.323-calls made utilize VPI/VCI values (labels) of pre-built PVCs 220 to reach AT&T Video Gateway nodes 140. Such paths are a preferred mode of connection. The video-call speed (n×64 or 384) is also selected when appropriate call-launch-GUIs are selected at the call originating H.323 client 180. Customer Premises-Router 216 (#2) if involved may initiate connection via the ATM-PVC using assigned VPI/VCI values (these VPI/VCI assignments may be pre-configured at the CPE-Router/IAD-device 216).

IP-packets carrying video-call-connect parameters flow from the Customer Premises Router 216 (#2) to the DSLAM-unit 219 (#3a or b) depending on using third party or AT&T DSL access (or directly to AT&T-ATM if using direct ATM/IP/FR access 220 shown by bold arrow) where multiple calls from the same customer premises are aggregated on a PVC, and, passed on to the ATM Core-network 150 (#4).

The ATM core-network 150 (#4) will pass the H.323 video-calls via pre-built (IVE specific) PVCs 221 to the egress ATM-port, for example, at a Chicago, Ill. office where the first gateway 140 according to the present invention is implemented. The egress ATM port is connected to the ATM-IMA router-card residing within the Gateway Network (GN) Router-box 205 (#5) (for example, a Redback SMS-500 router). H.323 video-call packets egress the Gateway Network-Router 205 onto, for example, an Ethernet (#6) local area network and Cabletron (#7) Hub 232. H.323 calls use the Gatekeeper (GK) 240-1 logic (#8) to complete the H.323 portion of the initiated call (each specific call may have in-built ALIAS=VTN and GK-IP-Address logic). [H.321 video calls supported by node 140, go to a Gateway Switch 243 (8A) prior to address-transcoding within a Gatekeeper 240-1].

All video-calls may share a common Gatekeeper (GK) 240-1. However, multiple gatekeepers 240 are possible for example for different categories of video calls. Gateways 241-1 through 241-3 may be selected on “least used basis” by the Gatekeeper (GK) 240-1 from within, for example, Vgate-1, Vgate-2, Vgate-3 or Vgate-4 (available from First Virtual Corporation) or other gateway appropriate to the task.

Upon reaching the Gateway-node 140, H.323/H.321 call related IP-packets are transcoded into H.320-protocol format to establish an ISDN video call connection via PRI-trunks 245 (#9) homed to the 4ESS-POP 228 of the GSDS network 120-1 (#10) in data-domain (domain-82). The H.320 (ISDN) call then terminates at the NANPN (or 700_VTN #) over PRI connection(s) 115-2 (#11a) where H..320 (ISDN) client 100-1 has direct access to the 4ESS-POP 210 {or, over BRI 213 (#11b) connection(s) for 128 kbps video-calls, where the H.320 (ISDN) client 100-2 has Digital Switched Access (DSA) from a LEC-switch 215 with Feature Group-D (FGD) trunk 214 equal access (EA) trunk connection to GSDS-subset 120-1 of the AT&T Switched Network (ASN) 120-0}.

For correct billing, a feature of the present invention is that the Gateway 140 may transmit, for example, out-pulse the 10-digit (10D) ANI of the Calling Party Number (CPN) into the GSDS network 120-1 via PRI 245. The Calling Party Number (which is the same as the H.323 client alias) is passed on to the network-biller for billing purposes [digits out-pulsed by the Gateway 140 will be 1+10D, if the Gateway-box is connected via PRI 245 to a local Class-5 switch.]

Incoming Video Calls (H.320 Originating to H.323 Terminating)

A call originating in an H.320 environment and terminating in an H.323 environment will now be discussed. Generally, the call stage numbers used above are called upon in reverse order in this direction. From a compatible video-CPE (codec), an ISDN H.320-client (customer) 100-1, 100-2 will typically select a call-connect-icon (module) from an appropriate graphical user interface and enters one or more destination NANPN (or VTN #) to be connected. The video-call type (n×64 kbps, 384 kbps, etc.) is also selected by the call originating ISDN H.320-client (customer) 100-1 or 100-2. Call connection requests are first processed per the current ISDN service-architecture and Q.931 ISDN-protocols. In the case of direct connect SDDN-calls, the call-originating AT&T-switch 210 handles the TCAP-process(es), call routing and destination translation functions using SDDN-records provisioned for a GSDS customer. The destination NANPN is out-pulsed. [In the case of BRI-calls from Digital Switched Access (DSA) via LEC 215, the call originating LEC-switch 215 passes the Calling Party Number (ANI) and destination NANPN to the appropriate 4ESS-switch of the GSDS network 120-1.] GSDS network 120-1 handles network routing and call translation functions, and, out-pulses call-destination NANPN.

Billing architecture for video-calls made by H.320-clients may be the same as existing GSDS-GISDN video call-billing-architecture for all calls {including those that terminate over a UNI-ATM port or DSL at the terminating end}.

H.320 originating and H.323 terminating video-calls come into the SDVG-node 140 via a Gateway-box 241-1 through 241-3 (GW-1/GW-2/GW-3 or GW-4, not shown) at the SDVG-node 140. The Gateway box 241 converts H.320 protocol to H.323 protocol among other tasks. Lookup-tables setup within a memory of the Gatekeeper (GK) 240-1 (#8) logic map translate NANPN to a H.323 client specific destination IP-address and inserts the mapped destination IP-address into IP-packet(s) for onward transmission to the ATM/IP network 150.

IP-packets from the SDVG-nodes 140 use specific VPI/VCI labels and pre-built PVC(s) 221, 220 to establish a connection between the originating-client 100 and the terminating-client 180. Such video call packets then flow through the ATM core network 150 (#4) to an appropriate recipient H.323 client 180 (#1.)

It should to be noted that H.323-client 180 (#1) needs to be in an “on-state”. The “on-state” is typically necessary for registration of the client with nodal Gatekeeper (GK) function 240-1. If the H.323-client 180 is not registered with the nodal Gatekeeper (GK) 240-1, an H.320 originating and H.323 terminating call will not complete. As indicated above, a status may be provided in a similar manner to instant message to a calling client 100-1 or 100-2.

SDVG Service Order Provisioning

This section will cover the steps necessary for SDVG service implementation for a particular customer. We will briefly mention the initial interactions that typically occur with a customer that has expressed interest in having SDVG service. Sections will describe equipment and access requirements at the customer premise prior to SDVG service being implemented. Once implemented, we then describe the steps that must occur to fully provision and implement SDVG service for a customer.

Once a customer (existing or new) contacts AT&T (or other carrier) concerning SDVG service, members of the customer's account team may begin discussions about the service with the customer. Discussions with the customer will include the customer's needs and expectations of the service. If necessary, technical support personnel may get involved to assist with technical issues. Service descriptions and technical information may also be available at a GISDN Network Technical Support website.

At present, customers can access SDVG service in at least two access types:

1) Symmetrical Digital Subscriber Line (SDSL) 218.

SDSL 218 is a broadband access type that provide customers “always on” digital connections with speeds of up to 1.5 mbps. SDSL access for SDVG service must be ordered from either AT&T Local Services (ALS) or an AT&T approved third party access provider (per 225). Customers and Account Teams will utilize existing ALS or AT&T Broadband processes and procedures for ordering the SDSL service. The ultimate goal of an AT&T SDSL access offering is to allow customers to simultaneously access the internet, in addition to originating and receiving quality voice and video calls. Bandwidth for SDVG calls presently ranges from a minimum 128K to a maximum 384K with Quality of Service (QoS) comparable to ISDN/H.320 video calls.

2) ATM Access Link 220

Customers with an existing private ATM network access link or new ATM customers who can get ATM Access Link to their premise will be able to access SDVG service via a Permanent Virtual Circuit (PVC) 220. That PVC will connect from the customer's existing ATM port to an AT&T SDVG ATM port. Dedicated T1.5 (inverse multiplexing over ATM (IMA) for multiple T1's) or T45 access can be pre-provisioned to provide shared access from the SDVG Node 140. Customer connectivity to SDVG 140 will require a PVC with the following parameters:

TABLE

| | |
|---|---|
| Virtual Path/Virtual Circuit (VPI/VCI): | assigned by the customer |
| Committed Information Rate (CIR): | 768K |
| Class of Service: | Constant bit rate (CBR) or |
| | variable bit rate Real time |
| | (VBR-RT) |
| Encapsulation: | 1483 (Routed) |

Other access types are contemplated including but not limited to cable mode M over facilities such as hybrid fiber coax and fiber to the curb Bluetooth and free space optical links.

At the Customer End Facility, CPE-Equipment, certain engineering rules may apply:

In designing the SDSL Network Interface, SDSL is a specific DSL-access-type. SDSL-clients may set up front-end IAD-device(s) 216 that will provide multiple ATM-ports for H.323/H.321 (IMA) video-calls configured in a “routed” mode (multiple services; specific IP routes required.)

In designing the direct ATM access, ATM access circuits will typically terminate in a router 205, switch 243, or other broadband access device. It is the customer's responsibility to provision and configure the CPE appropriately. The customer must also identify the ATM port and all of the virtual circuits (PVC's) that will be used to connect to the SDVG-port, including various characteristics and attributes such as their Class of Service, and committed information rate (CIR).

Also, H.323 (IP) video clients 180 must adhere to certain criteria in order to be utilized for SDVGS service. Those requirements include the following: Ability to register with an H.323 Gatekeeper 240; ability to send a calling party number (CPN) as part of the E.164/H.323 data stream; ability to dial a standard 10 digit off-net number and 10 digit 700 on-net number and ability to dial international calls (up to 16 digits)

H.323 (IP) video clients 180 that have been tested and meet the above requirements include the following CPE: the Polycom Viewstation 512, Polycom Viewstation V.35 (version 6.0), PictureTel Livelan 3.0, Sony Contact 323 (version 4.12) and FVC V-Meeting (in connection with a Click-to-Meet web interface). Other video clients may be developed over time that may serve equivalent purpose.

H.321 (ATM) clients will have the same requirements as mentioned above. Presently, the Polycom Viewstation V.35 system in conjunction with the FVC.COM V-Room IAD may be utilized for SDVG service. Additional H.321 video clients and IADS may serve equivalent purpose in the future. Each client provisioned will be identified and billed by being assigned a unique IP address and 700 number or a pre-assigned dedicated video NPA-NXX telephone number (VTN), which should not be changed unless the carrier, AT&T or other service provider is notified and the appropriate service orders are issued to change this information. Changing this information without prior notification could cause an interruption of service and/or a billing-error.

Now an overview of a Service Ordering and Provisioning Process will be described. Once the above criteria have been satisfied, SDVG service can be ordered. Each SDVG Service Node 140 consists of at least three-configurable primary components: an IP/ATM Gatekeeper 240-1, an ISDN Gateway such as 241-1 through 241-3, and an access router 205 otherwise H.323/H320 cannot be provided. The following sections describe the steps required to fully provision SDVG service.

For SDSL Access, a GSDSNCC Project Manager (PM) will obtain IAD and CPE information from Local Access Provider that includes: Type of IAD device (Flowpoint, Jetstream, etc.); is IAD bridged or routed (presently, bridging is not supported); IP address of H.323 clients or ATM MAC address for H.321 clients assignments; video Client type—PC (i.e. V-Meeting) or standalone VC unit (i.e. Polycom); DSLAM—ATM PVC info (VPI/VCI)

For ATM Access, the GSDSNCC Project Manager (PM) will obtain the customer's ATM Access information that includes: ATM Port # (VPI/VCI pair #), Video-client (CPE) make/model info, network terminating equipment (i.e. router, switch) make/model info.

Now Central Office provisioning will be described. First, one must generate an ATM Service Order.

For SDSL-Access, The GSDSNCC SDVG Project Manager (PM) will issue an ATM Engineering Service Order (ESOR) requesting a 768K ATM PVC connecting the closest SDVG Service Node port with the customer's local DSLAM port. The GSDSNCC PM will utilize the Corporate ITS (CITS) online web request system @ ‘web address to be supplied’ for all ATM PVC orders. The ATM SOR will include the following information: VPI/VCI pair, CIR=768K, Class of Service=VBR-RT (CBR if VBR-RT) not available and encapsulation=1483 (bridged or routed as appropriate).

For ATM-Access, the GSDSNCC SDVG Project Manager (PM) is responsible for ordering the PVC between the customer premise and the AT&T SDVG service node 140. Therefore, the customer must supply the port and PVC information as described above to the GSDSNCC PM. This information will be used to build the PVC between the SDVG router 205 and the customer's front-end-equipment. The GSDNCC PM will gather all pertinent data (ports, VPI/VCI, class of service) and may then utilize an online CITS System to order the ATM PVC.

Now, an assignment of VTN or NPA/NXX and IP addresses is performed. The GSDSNCC will be responsible to assign the VTN and static IP address that will be loaded in the customer's video client. SDVG Capacity Management will be responsible to maintain and update the list of available 700 #'s or NPA/NXX #'s and IP addresses.

A database for this application can be developed either, for example, as an Excel Spreadsheet or MS Access database. GSDSNCC preferably has online access; possibly access via, a website with password security.

Next, the Billing Service Order is generated. The GSDSNCC SDVG Project Manager (PM) will issue a billing service order to establish the customer's SDVG VTN or NPA/NXX# as the billing number of record. For SDS customer's, a SWAC (Switch Net) form will be fax'd to a Front End Center for input into, for example, the Convergys or other billing system. For SDDN customers, billing info will be input into the SDN OON system. All SDVG usage will be billed directly to the customer's VTN number.

Then the Router 205 is configured. The GSDSNCC technician will be responsible for configuring the access management router, currently, a Redback SMS 500, for SDVG 140. The router 205 may have an easy-to-use Web Interface (point and click) which will allow the technician to: create a subscriber profile (client IP address, secure-ip, ip source-validation, among other profile data) and build and bind an ATM PVC (1483 bridged or routed).

The router 205 may also be reachable via a telnet session over the AT&T corporate UGN network to a Management port of the router 205. This gives the user access to all configuration commands and can have adverse service affecting results if used incorrectly. Therefore, router access is preferably restricted to SDVG Capacity Management and Technical Support personnel. The GSDSNCC PM and/or technician should contact those organizations if problems occur with the router Web Interface.

Now, configuration of gatekeeper 240-1 will be discussed. The GSDSNCC technician will input customer specific information such as: the VTN, the IP address for H.323.clients and the ATM MAC address for H.321 clients

IP and ATM clients may be tracked. The SDVG Gatekeeper 240-1 keeps track of all registered IP and ATM clients 180. When an IP or ATM client 180 originates a call to a H.320 (ISDN) client 100, the Gatekeeper 240-1 will forward the call for completion to an available ISDN Gateway 241-1 through 241-3, which is connected to the public switched digital network PSDN via dedicated PRI's 245. Conversely, on a call incoming from ISDN, the 10-digit destination VTN is forwarded by the Gateway 241-1, -2 or -3 to the Gatekeeper 240-1. The Gatekeeper 240-1 will then do a look up in its database for a match of the VTN; if it finds a match it will then cross reference (translate from memory provided the destination client 180 is registered) the IP address associated with the VTN and will then forward the call to the appropriate H.323 or H.321 client 180.

Once all network circuits for a customer's configuration (PVC's, DSL access shown) have been installed and the associated SDVG equipment has been administered properly, a test to verify correct provisioning may be conducted. This test should confirm that all work required for SDVG 140 provisioning has been completed properly.

SDVG 140 Service Maintenance

This section addresses maintenance requirements to support SDVG Service. This service offering will utilize existing network accesses/services (ATM, GSDS, SDN, BRI, ISDN/PRI, Dedicated T1.5,), within its end-to-end architecture. This will help to minimize the impact of the offering on the various Work Centers involved, because basic existing maintenance support processes and interface agreements are already in place. However, SDVG 140 provides many features above the physical layer (i.e., beyond merely establishing an end-to-end connection and transmitting error free data) along with new equipment configurations (H.320-H.321-H.323 Gateway & Gatekeeper, Access Management Router, IAD device) and access arrangements (i.e. SDSL). It is these additional layers of detail (i.e., understanding the various protocols being offered, the new pieces of equipment being utilized in the customers' architecture and how they should be optioned, etc.) that needs to be incorporated into existing maintenance processes and associated agreements.

We now identify the work centers assigned to these areas of responsibility and list their major work activities. The section also identifies some additional sources of technical support when there are special needs.

The AT&T work centers that will have some degree of SDVG maintenance responsibility and involvement in the repair process, depending on a customer's architecture include the GSDSNCC in Chicago which will be the single point of contact for all SDVG impairments. Their maintenance responsibilities include the following: Open/Close SDVG trouble tickets, trouble analysis and sectionalization, and eliminate the trouble or refer the trouble to the appropriate group or work center.

An On Site Work Force (OSWF) at Chicago, 10 S. Canal, 12^{th} Fl may be responsible for maintaining the AT&T on-site equipment used in a customer's network configuration (SDVG Gateway & Gatekeeper, click-to-meet (CTM) Server, Ethernet Switch Hub, Router, etc.) along with the associated wiring and DSX cross-connects.

An IHSS-NOC (InterSpan High Speed Services—Network Operations Center) may be responsible for trouble maintenance of the Interspan ATM Network from the customer premise (ATM access) or DSLAM mini-T to the SDVG service node Mini-T (SDSL access). If all ports and PVC's are up and active then the IHSS-NOC will refer the trouble to the GSDSNCC Maintenance Center for further troubleshooting in the SDVG node and/or the PSDN.

A National ISDN Center (NIC) may be responsible for monitoring all PRI alarms and using their normal processes to proactively isolate and trouble shoot all SDVG PRI troubles.

An ACCUNET T1.5 Maintenance Center may be responsible for trouble maintenance of Private Lines, e.g., those used to provide connectivity from a SDVG router to the ATM port.

An SDNCC/VTNSCC/OneNet-CC may be responsible for resolution of SDDN troubles and problems with the customer's Call Processing Record stored in the 2NCP. A Local Access Provider (LAP) may be responsible for trouble maintenance of SDSL access and the associated network, serve as single point-of-contact to a Help Desk maintained by a customer for its end users, contact Vendor if SDVG access CPE trouble assist is require, maintain log of work performed to repair each piece of SDVG equipment, follow the established escalation plan to ensure troubles are resolved as quickly as possible.

When GSDSNCC Tier I and Tier II are unable to resolve a customer's service issue, the trouble may then be referred to GISDN Tier III/IV Technical Support for further assistance in resolving the trouble.

Local M&Ps at the GSDSNCC and other affected work centers may be modified to provide detailed work descriptions for SDVG maintenance. These M&Ps will also specify the coverage the center will provide (e.g., 7 days, 24 hours each), the response times to be expected when there is a trouble referral, and how the center's escalation process is structured. Existing interface agreements between the GSDSNCC and the above listed work-centers may also be modified as needed for SDVG service. Interface agreements with the IHSS-NOC for ATM may need to be established if none exist today. SDVG Product Management may establish agreements with vendors (as necessary) that will be supplying central office equipment (e.g. gateways, routers, hubs, etc.) such that each may become a part of the maintenance process in the following way: provide job aid that identifies vendor contacts, assist with preparation of M&Ps to provide guidance when experiencing equipment problems, e.g., how to handle a defective piece of equipment, provide on-line assistance when necessary; terms and conditions of these agreements must be negotiated. They should specify the coverage, (e.g., 7 days, 24 hours each), the response times to be expected from the vendor, and whether there is an escalation process. Lifecycle management will be responsible for negotiating with vendors following the initial service offering.

For SDVG service, access to the gatekeeper 240-1 and gateways 241-1 through 241-3 may be via a telnet session utilizing PC Anywhere or similar software. The gateways and gatekeepers will be configured as hosts and the GSDSNCC tech may utilize a Win95/98, or NT PC with PC Anywhere configured as a remote user. Once accessed, for example, the technician will see a window pop-up emulating the Windows NT screen of the gateway or gatekeeper being accessed. From there, the technician can configure any parameters and options of that device.

Future enhancements on the gatekeeper and gateway devices will enable SNMP type management access to the devices, which will be required for GA. LAN connectivity may be established with static IP addresses between the GSDSNCC and the service nodes either via UGN or private facilities. This will allow real-time monitoring of all SDVG network components by the GSDSNCC including: Gatekeeper servers, shows all active registered users (VTN's & associated IP addresses, active gateways), call detail data, performance reports, etc., gateway servers; monitor PRI status and utilization; routers; shows PVC and subscriber data (IP, VPI/VCI, security options). Also monitor utilization of ATM and Ethernet ports, binding information, etc., switch hubs, monitor hub port utilization and activity. Access to the above information should assist the GSDSNCC tech in isolating and resolving customer reported troubles with their SDVG service in a timely manner.

SDVG customers may be instructed to report troubles to the GSDSNCC (Global Switched Digital Services Network Control Center) in Chicago. However, it is possible the Local Access Provider or one of the following AT&T work centers could also receive the initial customer trouble report:

SDNCC (SDN Control Center), VTNS Control Center, OneNet Control Center, IHSS-NOC (InterSpan High Speed Services-Network Control Center) [ATM Maintenance] NIC (National ISDN Center), and ACCUNET T1.5 Maintenance Center.

Each of the above listed work-centers check and clear their portion of the SDVG service, for example, the SDNCC checking that all databases are loaded correctly or the IHSS-NOC has checked that all ATM ports and PVC's are configured correctly and are active. If any of the above work-centers identifies a problem it is their responsibility to correct it and report back to the customer based on existing procedures and policies.

If no problem is found, then the work-center that took the trouble report should refer the trouble to the GSDSNCC for further troubleshooting per existing practices. It will then be the GSDSNCC's responsibility to report status to the work center that took the original customer trouble report.

After a center opens a trouble report, the objective is to sectionalize, or isolate, the trouble (i.e. to identify whether the trouble is) to one or more of the following: in the originating customer's CPE, the SDSL access circuit, the GSDS network, the customer's SDVG equipment configuration, the ATM network or private line network to the customer's corporate LAN or the protocol application being used (e.g. H.323 or H.321). This step requires that appropriate diagnostic tests be conducted to determine whether it will be necessary to refer the trouble to another work center. This may require the GSDSNCC to have access to a Protocol Analyzer (e.g. Radcom, PrismLite) that can monitor both ATM and Ethernet protocols. In addition, diagnostic tools available in the router can also assist in this step.

In order to better handle SDVG trouble tickets, it is recommended that all centers that may receive trouble reports should receive a level of SDVG training. This training should range from a service overview document (e.g. SDNCC, NIC center) to possibly on-site training that covers details of the service and architecture (e.g. GSDSNCC, IHSS-NOC).

A GSDSNCC technician performing trouble sectionalization will be able to retrieve important information from the gatekeeper 240 and router 205 such as the user VTN, IP or ATM MAC address, and routing information. In addition, for the initial service trial, a database will be maintained containing customer specific CPE information (e.g. IAD, video client info, etc.)

For example, if the technician suspects that the trouble has occurred due to changes of data in the customer's IAD or video client (e.g., IP or CPN info), the technician will be able to retrieve the customer's profile and related info to determine whether inappropriate changes have been made. An online database may capture above listed data. This can be web-based (for example, NTS Web Site) or SQL type database.

Following these tests for trouble sectionalization, the trouble will be referred by the GSDSNCC as follows if further investigation is required utilizing existing procedures and processes. For DSL access, refer the ticket to the Local Access Provider. For Gateway PRI troubles, refer the ticket to the NIC. For call blocking due to insufficient PRI available channels, refer to GISDN Capacity Management in Bedminster, N.J. ATM related troubles (i.e. PVC or port related troubles) should be referred to the IHSS-NOC. A detailed interface agreement will need to be negotiated and agreed to by both the GSDSNCC and the IHSS-NOC that will clearly delineate what constitutes a valid trouble that should be reported to the IHSS-NOC for ATM troubles.

The customer will be kept informed concerning the status of the trouble ticket as specified in existing procedures and practices. Determining why a customer is having trouble may require extensive testing and analysis by either the GSDSNCC or the center to which the trouble was referred. For example, testing of the switched digital network or ATM network, testing of DSL access network, testing of CPE, testing of the customer's SDN or SDS database, etc. On the other hand, if the trouble is due to a failed or malfunctioning device in the SDVG equipment configuration, the GSDSNCC technician will remote access to the defective equipment via the web interface (as described in above) to determine if the failure is due to a software or hardware problem. If unable to remote access to any particular device, the GSDSNCC technician will then engage an OSWF technician to access the defective device directly.

When a particular device fails and cannot be repaired in place, the GSDSNCC technician will request the OSWF to replace the failed device with another out of the spare inventory. Once all connections have been made to the replacement device, the GSDSNCC tech will verify remote connectivity to the device and configure as needed in order to be placed back in service. The Local M&Ps for the GSDSNCC will specify the detailed procedures to be followed in order to restore failed SDVG equipment.

Procedures specified by the Local M&Ps will be followed to make the necessary repairs/modifications to the GSDS, ATM, or DSL network, the customer's SDN call processing record, the SDVG equipment configuration, etc. If a trouble is CPE related, the GSDSNCC at the customer's request, will continue working with them or their Vendor to resolve the problem. At this point the customer reported trouble ticket should be closed out as CPE, and a new “info” ticket should be opened for a test assist. When appropriate, status reports should be made to the SDVG customer concerning the progress of the repair operation. As soon as the trouble has been cleared, the trouble will be referred back to the controlling organization, if appropriate.

A Customer Trouble Reporting (BMP) system may be modified as follows: recognize “SDVG” as a new Type of Service code, recognize the new CWC code to ensure that SDVG trouble tickets are routed to the GSDSNCC and recognize a new Analysis Code pertaining to SDVG troubles.

If a trouble that was referred from the GSDSNCC to another center is not repaired within the interval specified in the Maintenance Interface Agreement between the GSDSNCC and that center, the GSDSNCC should invoke escalation procedures. A detailed escalation plan pertaining to both centers must be included in the Local M&Ps and each Maintenance Interface Agreement.

The center opening the trouble ticket has the responsibility to close it. Before doing so, the center planning to close the ticket must contact the customer to verify that the trouble has been cleared and service is back to normal. Standard procedures for repair verification should be followed for SDVG.

If a trouble is identified as CPE related then please refer back to Step 6 preceding for additional steps that may be required.

To perform any provisioning and maintenance activities on the Router 205, for example, a Redback router, it is necessary to establish a session. Establishing a session on the router is done by connecting a cable to the COM1 port on the laptop, or remotely via a UGN-TELNET. It is very important to remember that logging on to the Redback Router gives you super-user access and activities are service effecting. Recording your activities during this session is important in the event of a mistake.

A valuable source of information concerning the Redback Router is the Access Operating System (AOS) Configuration Guide. The document, published by Redback Networks, the manufacturer of the router, and incorporated herein by reference gives a system overview and an introduction to the User Interface. It explains the loading, maintaining, and managing of the system. It then goes in depth on the configuring of the system. All configuration changes performed at the Command Line Interface (CLI) are dynamic and take effect on the active system immediately.

To perform some maintenance activities it may be necessary to reboot the Redback Router. To Reboot, use the monitor and follow these procedures: Close all running applications; Click “Start” and click “Shut Down”; Click “Restart” and Click “OK”; the machine will shut down and then restart. Once machine has restarted, screen will appear. Press “ALT CTRL DEL”, the Password screen will then appear. No password is necessary and hit enter key. Double click on V-Gate 4000 Manager icon; V-Gate screen appears and click “Connect” button on screen

Connect screen will appear. Type in IP Address “135.46.80.125”. Leave application running; Double click on V-Gatekeeper Mgr icon; V-Gatekeeper Mgr screen appears with green connect light. On bottom of screen will be list of Type, Alias/Endpoint ID, etc. The three lines below should be listed:

| Gateway | FVCGK000001b1@135.46.80.125 |
|---|---|
| Terminal | 9085472008 |
| Terminal | 9085472009 |

If terminals are not on list then reboot Polycom units.

The Redback Router session expects commands to perform the task requested and these commands are listed at the end of the section. Activities performed during normal telephone provisioning and maintenance are defined differently by the Redback Router. The Terms and Definitions used during the session are listed here:

1). Context: a virtual router within the Subscriber Management System (SMS). A context is a logical construct that provides a separate security, management, and operating environment on behalf of a given network.

2). Interface: a logical construct that exists within a given context. An interface defines a layer 3 subnet directly connected to the context.

3) Port: a physical connection. A port is where network cables are connected to the SMS modules.

4) Circuit: Within a port, circuits carry individual subscriber traffic. From the SMS point of view, a circuit is a physical, fixed end-to-end link terminating at the subscriber and at the SMS port.

5) Bind: The process of making the connection from the physical circuit on a port to the logical interface with a context.

6) Subscriber Database: The list of subscribers and their individual characteristics, such as addressing and authentication information. The subscriber database is defined within each context.

For understanding these terms, the following interrelationships may be useful: Subscribers come in on circuits; Circuits are attached on ports; Interfaces are logical constructs for IP data streams, and are located within a given context.

The circuits on the physical ports are bound to the logical interfaces on the contexts.

A feature of the SMS lies in how we make the binding from the circuits on the port to the interface on the context. Bindings are either statically mapped during configuration, or are dynamically created based on subscriber characteristics as defined in the local database or on a RADIUS server (refer to FIG. 3). Once bound, traffic flows through the context as it would through any IP router.

To add a customer to the router 205, one builds a PVC, adds the customer information, and then connects these two together. In Redback terminology this is CREATE PVC, CREATE SUBSCRIBER, and BIND A SUBSCRIBER TO A PVC.

To CREATE PVC, one follows the following:

1. At [local]RedBack# prompt, type “config”.

2. Prompt will now read [local]RedBack(config)#. Type “port atm 4/0”

3. Prompt will now read [local]RedBack(config-port)#. Type “atm pvc 1 53 profile ubr encapsulation route1483” (can also be bridge 1483)

4. Bind pvc to subscriber to be assigned to that pvc (i.e. “bind subscriber pvc 150@local” (subscriber name @context)

5. Prompt will now read [local]RedBack(config-pvc)#. Type “end”.

6. Prompt will now read [local]RedBack#. Type “show configuration” and updated configuration will be displayed.

To CREATE A SUBSCRIBER, remember that names will be used again in the bind command on the circuit. Make your names easy to remember and to type. Alternately, one may use a RADIUS server to build a subscriber database. Defining the subscriber places one in a subscriber configuration mode. All subsequent commands will refer to the named subscriber until you enter another subscriber name or change to another mode.

Create Subscribers

At the [local]Redback (config-ctx)# prompt type “subscriber name <name>”

Assign Address

At the [local]Redback (config-sub)# prompt type “ip address <address>”

Example

[local]Redback (config-ctx)# subscriber name joe

[local]Redback (config-sub)# ip address 10.1.1.2

To BIND A SUBSCRIBER TO A PVC, one follows the following steps. Before defining the individual circuits on a port, set the medium-specific parameters. A circuit definition includes the circuit identifier, VPI/VCI for ATM or Data Link Connection Identifier (DLCI) for frame relay, the traffic shaping profile, and the circuit encapsulation—bridge, route, or PPP. Bind commands are always accepted if the syntax is correct. However, if a subscriber record does not exist when the bind command is entered, the bind will fail. Creating subscribers after the bind commands have been entered requires that the circuits be cleared before the bind will commence.

In one embodiment, names—profiles, subscribers, interfaces, and contexts—are case-sensitive and cannot be abbreviated.

The command of “no bind” deletes a previous binding of subscriber.

To bind a subscriber to a PVC:

specify the port

[local]Redback (config)# port <type><slot>/<port> set medium-specific parameters

[local]Redback (config-port)# call-delineation [plcp|hcs] define PVC (creates PVC)

[local]Redback (config-port)# atm pvc <vpi> <vci> profile <name> encapsulation <type>

[local]Redback (config-port)# frame-relay pvc <dlci> profile <name> encap <type>

and set binding

[local]Redback (config-pvc)# bind subscriber <name>@<context>

Referring to FIG. 3, the Redback Router's Access Operating System (AOS) software has addressed the security concerns such as address spoofing, denial-of-service attacks, and redirecting of traffic by including an option called “Secured Address Resolution Protocol (ARP)”. With secured ARP, a user cannot make up an address for a new host and thus deny service to its rightful owner or addresses cannot be spoofed, eliminating the ability to steal another user's traffic. Secure ARP also prevents one IP client from calling another IP client through the router 205, which would be considered fraud. Secured ARP is manually enabled and built at the ATM interface between H.323 clients and applies to all PVCs (clients) that use this interface. An example of enabling Secured ARP at the ATM Interface when building a context is:

context thom1

interface yarbrough

ip address 192.168.3.1 255.255.255.0

ip arp arpa

ip secured-arp (Secured ARP option)

atm profile ubr

counters 12 multicast

shaping ubr

atm profile cbr

shaping cbr rate 768 cdv 10

port ethernet 0/0

bind interface remote local

port ethernet 3/0

bind interface labether1 labnet1

port atm 4/0

cell-delineation plcp

port atm 5/0

clock-source line

atm pvc 1 50 profile ubr encapsulation route1483

bind subscriber sony@labnet1

atm pvc 1 51 profile ubr encapsulation bridge1483

bind subscriber poly@labnet1

port atm 5/1

clock-source line

port atm 5/2

Other security measures are accomplished by “IP Source Validation” that prevents clients from using invalid IP Addresses (spoofing) and Point-to-Point Protocol (PPP) Over Ethernet (oE), or PPP-oE. Within the context, all subscriber authentication, authorization, and accounting (AAA) is accomplished either through local configurations (subscriber profiles) or through a remote server.

In accordance with FIG. 3, a router may use a radius server (RS) for querying an H.323 gatekeeper 240 to verify its status and will preclude video packet delivery until a predetermined event has occurred. FIG. 3 is a simplified block diagram showing operation of the router of FIG. 2 for securing video services between H.323 video clients from theft of service whereby the router separately queries the gatekeeper 240 to assure that an H.323 control channel session is in progress, otherwise, the video packets will not be routed.

Typically, steps 301a and 301b, performed once a router has received an originating H.323 call at step 310, are control channel session steps associated with setting up routing control channels via Gatekeeper (GK) 240. At the same time, these control channels are set-up, the Gatekeeper 240 is involved in billing and other relevant actions at gatekeeper (GK) 240 susceptible to piracy. Consequently, according to the present invention, steps 320 through 350 are recommended either via a radius server (RS) or, if possible, directly with Gatekeeper (GK) 240 to assure the control channel session is in process or has occurred. A positive response at step 350 may trigger the forwarding of video data packets at step 360 indicated terminating H.323 traffic to addressed H.323 destinations. In one embodiment, since the gatekeeper 240 control channel session should not take long to accomplish, terminating H.323 traffic is allowed to proceed but is terminated if the control channel session is not proceeding or has taken too long to complete. In an alternative embodiment, terminating H.323 traffic is buffered until the control channel session has successfully completed.

The commands that are used during the session with the Redback Router (if used as router 205) are listed here and are used at the {local} RedBack# prompt.

| | |
|---|---|
| aps | APS Commands |
| atm | ATM Commands |
| bert | Enable a BERT test pattern |
| bulstats | Manage bulk statistics collection file |
| clear | Clear information |
| clock | Manage the system clock |
| configure | Enter configuration mode |
| context | Set the operational context |
| copy | Copy a file |
| debug | Modify debugging parameters |
| default | Return an option to it's default value |
| delete | Delete a file |
| directory | List contents of a directory |
| exit | Exit exec mode |
| format | Format a device |
| frame- | Send test patterns on a Frame Relay port |
| relay-test | |
| ip | Global IP administration |
| log | Commands for dealing with the event log |
| mkdir | Make a directory |
| module | Module commands |
| no | Disable an interactive option |
| ping | Packet Internet Groper Command |
| reload | Restart the system |
| remane | Rename a file or directory |
| rmdir | Remove a directory |
| save | Save system information |
| show | Show running system information |
| sshd | Execute SSHD Commands |
| telnet | telnet to a host |
| teminal | Modify terminal settings |
| traceroute | Trace route to destination |

Network Capacity—Facilities

GSDS network intertoll capacity is determined by historical data and forecasts from Product Management and includes trunking for intertoll and access. The DMOQ concerning capacity is Grade of Service (GOS) and is measured and managed to meet a Grade of Service of B.001, 1 in a 1000 calls blocked for intertoll and B.01, 1 in a 100 calls blocked, for Access trunks.

The GSDS INTERTOLL trunking is a tandem architecture and consists of ten tandem switches. Each tandem connects to all other AT&T 4Es with at least one T1 or 24 trunks. The capacity of this minimum trunking is 120 128 Kbps Video Calls or 40 384 Kbps Video Calls or a combination of both. However, most tandem connections exceed minimum connectivity and can provide more video capacity.

An AT&T Video Gateway-node 140 will be connected to an AT&T Local Switch via individual PRIs from the gateway-boxes (GW-1, GW-2, GW-3, GW-4.). The AT&T Local switch is then connected to the GSDS Network 120-1 via Feature Group-d (FG-d) trunking. The Video Gateway-node 140 is located at Chicago-NCC and uses the AT&T CHCGILCLDS7 local switch, which in turn is connected to the CHCGILCL59T AT&T 4E.

The GSDS Network Manager—Access has assessed that the maximum FG-d trunking should not exceed the number of PRI channels from the node to the Local Switch. The capacity of the SDVGS equipment is irrelevant to the maximum capacity of the transmission path to the network. Coordination of the PRIs and Local Switch trunking is necessary to meet the demand.

Network capacity is determined by historical data and forecasts from Product Management and includes trunking for intertoll and access. The DMOQ concerning capacity is Grade of Service (GOS) and the GSDS Network trunking is measured and managed to meet a Grade of Service of B.001, 1 in a 1000 calls blocked for intertoll and B.01, 1 in a 100 calls blocked, for Access trunks.

The GOS for the intertoll network is maintained by daily monitoring for high usage and blocking. The interval for augmenting a network trunk group is 120 days when all facilities and equipment are available. Shorter intervals can be expedited when necessary.

The SDVGS offering is connected to the GSDS Network 120-1 via PRIs 245 from the Gateway equipment to an AT&T Local Switch or an AT&T 4E switch 228. The local switch 215 is connected to the GSDS Network via FG-d trunking 214.

The FG-d trunks are identified with a BBS0 modifier in the trunk identification. The modifier indicates that the trunks are 64C capable, use SS7 signaling, and are carried over a B8ZS-ESF facility. The trunks may be digitally tested at 64C when provisioned by the Denver NSP. The trunks are monitored on a daily basis and meet the GOS of B.01 for access trunking.

The GSDS Network Manager—Access has assessed that the maximum FG-d trunking should not exceed the number of PRI channels from the node 140 to the Local Switch 228. The capacity of the SDVGS equipment is irrelevant to the maximum capacity of the transmission path to the network. Coordination of the PRIs and Local Switch trunking is necessary to meet the demand.

PRI Requirements are for a minimum 23 B channels and 1 D channel, ISDN-SDS/SDDN 64 only, 10 digit DNIS, ESF/B8ZS Signaling, 23 700 Numbers assigned, assigned to existing trunk group or if new order assign all PRIs to same trunk Group, SDVG Indicator (Spare 10) field on nodal TSG field set to “Y”.

The following video client equipment may be used in the present system:

1). FVC.Com client & Portal via Webrowser MSIE 5.0 or greater.

Version 1.1059 or 1.060. Can be used as a (standalone) end-point client. Or, used with FVC Click-to-Meet Server with Webpage (Portal) using MSIE 5.0 or greater. Also, MS NetMeeting 3.01 (capable). H.323/H.320 Video speeds selectable from 112K to T 1.5M over LAN. Video Camera(s) tested: USB Win 98'—3Com, Logitech, IBM.

2). IBM (Xirlink)—Digital PC Video Camera.

USB connection, Version 3.0.0.5. CD-ROM installs own version of MS NetMeeting—3.01 on Laptop or dedicated (standalone) PC. H.323/H.320 Video speeds are selectable from 112/128K over ISDN BRI to full T1.5 over LAN facilities. Laptop (clip) provided. Win 98' tested compatible with FVC.Com client 1.1060

3.) 3Com—PC (Home Connect) Video Camera.

USB connection, Version 6.6.1. CD-ROM installs on Laptop or dedicated (standalone) PC. Works with MS NetMeeting 3.0.1 or FVC client. H.323/H.320 speeds are selectable from: 112/128K to T 1.5M over LAN facilities. Win 98' tested compatible with FVC.Com client

4.) RADvision—MCU LAN/WAN.

Video Multipoint—LAN/WAN based solution. H.323 end-points must be registered to MCU (Internal) Gateway to access the LAN for H.323/H.320 Video calls. H.323/H.320 speeds are selectable from 112K to T 1.5M. A separate WAN (L.323) device to ISDN PRI facility has its own Gateway (if needed). RADvision MCU calls setup and tested using MS NetMeeting 3.01 with 3COM, IBM and Logitech Video cameras.

5.) Polycom—Video Codec.

H.323/H.320 Video Codec's. Software: Version 5.5 on H.320 (Quad-BRI) unit. Version 6.0 on (3)—H.323—IP)) Units. H.320 ISDN based unit accessible via ISDN (Q.931) PRI facilities. H.323—IP based units accessible via (UGN) LAN to FVC Gateway NT Servers. All Polycom V/C's assigned IP Addresses on same sub-net as FVC Gatekeeper/Gateways, 135.43.22.xx. H.323/H.320 speeds are selectable from: 112K to T 1.5M over LAN/WAN (available bandwidth). All units tested and capable.

6.) Picturetel Live LAN.

Version 1.0. Hardware solution installed on dedicated (standalone) PC. H.323/H.320 Video calls made through PTEL Gateway via LAN. H.323/H.320 speeds are selectable from 112/128K to T 1.5M, (depending on allowable bandwidth from LAN network). Tested via PTEL Gateway to LAN.

7.) Logitech Express—Digital PC Video Camera.

USB connection, Version 5.3. CD-ROM installs own version of MS NetMeeting—3.01 on Laptop or dedicated (standalone) PC. H.323/H.320 Video speeds are selectable from 112/128K over ISDN BRI to full T1.5 over LAN facilities. Win 98' tested compatible.

8.) Intel Proshare—PC Video Camera.

H.320—Hardware/Software connection to dedicated (standalone) PC or docking station. IBVS, Version 5.0 software. S/T interface (hardware) on PC with NT-1 required for Q.931 ISDN BRI 2 to 4W conversions. Bandwidth available: 112K/128K only. Access available only over Q.931 ISDN (LEC) BRI facilities.

9.) Sony—Video Codec.

H.323—IP based, Video Codec. Software: Version 3.80 & 4.50. H.323—IP based units accessible via (UGN) LAN to FVC Gateway NT Servers. Both Sony V/C's assigned IP Addresses on same sub-net as FVC Gatekeeper/Gateways, 135.43.22.xx. H.323/H.320 speeds are selectable from: 112K to T 1.5M over LAN/WAN (available bandwidth). All units tested and H.323 capable. Needs software update, doesn't pass CPN at this time.

Process for AT&T Video Gateway Provisioning and Billing

The following gives the details associated with process for ordering, provisioning, and billing of AT&T Video Gateway services. The beginning section reflects a general outline of the ordering, provisioning & billing processes. The second section gives the detail information concerning ordering, provisioning, and billing process.

A typical outline of a billing process follows:

1) Account Executive (AE) forwards the AT&T Video Gateway ordering form to Channel Manager(s).

(Order Form in development)

2) Channel Manager reviews order form to assure all necessary information has been completed. A completed and accurate order form is sent to the AT&T Video Gateway Project Manager at the GSDSNCC.

3) AT&T Video Gateway Project Manager reviews the order form for completeness, assigns the 700 numbers needed by the customer, determines SDS or SDDN type of billing and related network components the customer wants, sends order form to a technician dedicated to AT&T Video Gateway provisioning task, establishes 700# for customer in SMS, SSIRS, and the NCP as SDS or SDDN, establishes dedicated SDS or SDDN billing order to establish a AT&T Video Gateway account, and sends Router, Gateway, and/or Gatekeeper provisioning information to the GSDSNCC-site technician (dedicated to AT&T Video Gateway project). If customer wants SDS or SDDN switched billing, GSDSNCC-site technician will send order form to designated Customer Care Center to establish AT&T Video Gateway-account. GSDSNCC-site technician will post completion of work to AT&T Video Gateway Project Manager. Chicago Provisioning Center will post Network update and billing completion to AT&T Video Gateway Project Manager. Designated Customer Care Center will post account establishment to the AT&T Video Gateway Project Manager. When all necessary order completions have been posted back to the AT&T Video Gateway Project Manager, AE/Channel Manager will be informed, about service turn up for the customer. The the customer uses service. A biller (designated for the customer) generates AT&T Video Gateway bill.

Provisioning Overview

The provisioning steps that need to occur to establish a AT&T Video Gateway service to a customer will now be described. Internal detailed AT&T Video Gateway: router, gateway, and gatekeeper, provisioning requirements have been described above. Provisioning functions that occur when a customer registers for AT&T Video Gateway service are: 1) Telephone Number Assignment—for calls routed via the AT&T Video Gateway, 2) Network Provisioning—Establishing the assigned telephone number in the network SMS, SSIRS, and NCP databases with customer information as SDS or SDDN.

Provisioning the Biller—establishing the customer assigned telephone number and customer information into the appropriate biller.

The customer is responsible for establishing their connectivity to the SDVGS Gateway 140. The connectivity will provide the means of placing a telephone call to the SDVGS Gateway. Customer connectivity will be either DSL or ISDN. Gatekeeper H.323 to H.323 calls (ATM or Frame Relay) provisioning is also the responsibility of the customer.

The AT&T Video Gateway Project Manager will allocate telephone number/s to the customer. These telephone number/s will be provided to the customer and will be utilized to perform network routing and billing functions.

A block of telephone numbers will reside on the SDVG 140 database. These telephone numbers will either be 700 569 XXXX for SDDN and 700 568 XXXX for SDS. When a customer registers with AT&T for SDVG service, the customer will be assigned the needed telephone number/s from the SDVG database. These telephone numbers will only pertain to specific customers for as long as the customer is an active SDVG customer.

The customer may either be an SDS or SDN/SDDN customer. The network SMS, SSIRS, and NCP will need to be loaded with the telephone number and customer information to indicate the customer's service preference. The specified NCP will be loaded as the customer registers for SDVG service and specifies their service preference.

The customer in designating SDS or SDN/SDDN will indicate the biller. A Billing Only order needs to be generated to the appropriate biller. For specifics on generating a billing order to the biller, see the Billing Section of the TSD.

The GSDNCC will provide an A4 manager as the SDVGS project manager. The project manager will also have the SDVGS technicians responsible for updating and maintaining the SDVGS routers, gateway, and gatekeeper equipment. The SDVGS technicians will also be responsible for maintaining service and working outages or customer issues to resolution.

The Chicago Provisioning Center will be responsible for updating the SMS, SSIRS, and NCP network databases with the 700 number customer designated information.

Billing Overview

Billing for SDVG service has different components that will be defined in the documentation written below. One component is the type of bill the customer wants to receive as in a SDS/SDDN switched or dedicated bill. The other component details the type of usage the customer can generate for billing.

When the customer initiates the request for SDVG service through an AE, the customer must identify whether they are to be a SDS or an SDDN customer. The customer must also identify whether they want the SDVG service as part of an existing account or they want to establish a new account for SDS or SDDN.

When the billing criteria has been established through the customer, the order form will relay this information to the SDVGS project manager. The SDVGS project manager will send the needed order form to the appropriate Customer Care Center to establish the customer SDVGS account.

The Customer Care Center will initiate the necessary billing only order to the appropriate biller to establish the account.

The Customer Care Center will notify through a confirmation on the order form, that the billing only order has been completed and the confirmation is sent to the SDVGS project manager. The SDVGS project manager will notify the AE when the billing and other service components have been completed and the customer's service has been installed.

SDVGS service can generate two types of usage. One type is generate through the AT&T network switch as AT&T PRI ISDN usage and would be billed through RICS AMA to MPS rating of the usage and transmitting the usage detail by 700 number, to the appropriate SDS or SDDN biller. The other type of usage is generated through calls placed through the SDVGS Gatekeeper.

These calls are IP based and the recording of the usage occurs through the SDVGS Gatekeeper. The usage detail generated through the Gatekeeper will be sent to the Convergys billing vendor for rating. When the vendor has rated the calls, Convergys will transmit the rated usage to the appropriate SDVGS SDS or SDDN biller. Gatekeeper usage will be rated utilizing existing tariff rates for SDS and SDDN.

The Convergys biller will bill both the ISDN and Gatekeeper SDVGS service components for SDS switched and dedicated services. The CBS biller will bill both the ISDN and Gatekeeper SDVGS service components for SDDN switched and dedicated services.

The Chicago Customer Care Center will be responsible for establishing the Billing only order for SDS dedicated SDVGS customers through the WATS/SOP ordering system. The Chicago Customer Care Center will also be responsible for establishing the Billing only order for SDDN dedicated SDVGS customers through the OCS/SS ordering system.

SDS switched SDVGS customers will have their billing only orders initiated through the SDS Pittsburgh Customer Care Center, utilizing the DSA/SM ordering system.

SDDN SDVGS switched billing only orders will be issued through a SDN Customer Care center as yet to be determined utilizing the OCS/SS ordering system.

AS stated previously, these centers will be responsible for notifying the SDVGS project manager of billing only order completion.

The account maintenance, customer inquiries on their bill, will occur through the Global ISDN Account Inquiry Center and will be managed as SDS inquiries are done today.

SDVG Disaster Recovery

A Disaster Recovery Plan, or a documented theory to provide the AT&T customers with seamless service interruption, is essential for any service but particularly for a new service such as SDVGS. From the beginning, establishing a good customer attitude towards AT&T's service reliability is paramount to the AT&T Goals for Customer Care. The customer requires the confidence that service will be available when it is required.

The Plan provides direction to AT&T Work Center personnel in Chicago to react to various service effecting situations and for them to provide direction to other work centers to resolve the isolated trouble in a timely manner. The Plan describes how work center personnel can respond to emergencies or disasters that render the SDVGS service partly or completely impaired. The Plan reduces the dependency of work center expertise to facilitate the recovery from a disaster in a more timely and organized fashion.

The Plan does not supercede any established procedures for trouble sectionalization. The Plan pertains to service recovery of all SDVGS dedicated equipment which include all NODE equipment and software and dedicated facilities for various accesses to the GSDS, ATM, and FRAME Networks and LNS offices. The Plan does not cover the responsibilities of troubles sectionalized on the various networks. The GSDSNCC technician covering the SDVGS Node would refer these troubles to the appropriate service work center.

The Plan will partition each section of the SDVGS service architecture and provide a alternative or duplicate path to insure, for example, 100% service availability. Areas to be explored for possible backup, alternate path or redundancy are accesses/egresses to the various networks, node equipment and software, and customer registration information. Description of switching from failed equipment will be given.

The level of redundancy of equipment, software, and facilities is a matter of design choice. For example, a high level of BACKUP can be used as a sales tool to insure the customer has numerous network paths and equipment duplications that will provide the most reliable video service offered.

During service deployment, a location such as the Bedminster or Morristown Labs can act as a Disaster Recovery location. A daily backup of customer information should to be scheduled.

As the SDVGS service grows, any Disaster Recovery Plan will be a living document to address and correct any disaster recovery processes.

The AT&T location providing the Gateway feature, providing H323 IP customers connectivity to AT&T H320 SDS Network customers and vice versa, is known as the SDVGS NODE. The Primary Node location has been established in the AT&T building at 10 South Canal Street, Chicago, Ill.

The node equipment at this primary sight may require redundancy or backup in the event of a disaster or an event that would cause impaired service.

The registration of customer billing information is necessary for a customer to complete a call. The backing up of the information, daily, is probably an AT&T requirement as well as essential for service performance.

Recommended is the Node technician be scheduled to a nightly down load of all software and Customer Registration Information, both historic and new. The back up provides a current record of all pertinent customer data. The procedure for backing up this type of data is a daily back up of previous day activities, a weekly backup of the complete week, and a monthly backup to be filed for retention. This backup activity provides recovery of all data prior to the last daily backup. Backing up to a remote server adds further security to this activity.

Backing up software and customer registration information is important. This activity could also include ticket analysis information, since RMINs may be phased out.

Access to the ATM and Frame Relay Networks

The provisioning of alternate accesses to ATM and Frame can provide disaster recovery advantages and secondly provide added capacity. ATM circuits connecting from the SDVGS Node to the ATM switch, this connection should be duplicated to a different ATM switch as backup or added capacity. The same is true for a Frame Relay connection.

Providing and using alternate routes to the ATM and Frame networks would not require periodic testing for continuity/availability because the facilities are always being used versus just being there for backup.

One recommendation is to have multiple connections from SDVGS Node 140 to both the ATM and Frame Relay Networks 150.

Access to the LNS Switch for Switched Access to GSDS Network

AT&T ISDN PRI T1s connect the SDVGS Node to a LNS switch. In the event of a failure on these T1s, the ISDN Work Center would resolve trouble.

H323 IP subscribers calling H320 GISDN subscribers will be using NANP NPA-NXX numbers, the Gateway routes the call to the GSDS Network, and the call completes.

The provisioning of multiple PRI TSGs to access the LNS switch from the Node or if other LNS switches are available in the area, a connection to multiple LNS switches should be considered.

The advantages of these alternatives is that they provide alternate paths via more than one PRI TSG and multiple connections to two different LNS switches provides alternate paths plus more capacity. The second provides two routing paths and more capacity since all trunks would be available.

Calling from H320 GISDN to H323 IP, the subscriber is always dialing a 700 number which is translated to an APN in the GISDN Network and directed to a 4E and a PRI to the LNS switch. The Feature Group-d TSG at the LNS switch is not used for incoming calls to the SDVGS Node 140, all egress to the SVGS Node use dedicated access.

One recommendation for this scenario is multiple PRI TSG connection from Node to LSN Switch and when available multi LNS Switch connections.

The dedicated access (ISDN PRIs) used to connect the SDVGS Node to the GSDS Network will process all H320 ISDN calls from the GSDS Network to the SDVGS Node and some of the calls in the other direction, H323 to H320.

For ISDN calls, subscribers will dial 700 numbers that translate to an APN number which are routed to the 4E that connects to the LNS Switch via ISDN PRIs. The PRIs between Node and 4E can be built as multiple PRIs and have hunt routing assigned. This egress to the Node is the preferred method for ISDN customers.

One recommendation for this scenario is multiple TSGs built from AT&T 4E to the SDVGS Node with hunt type trunk picks.

The hardware in the SDVGS Node 140 is listed below. Replacement of this equipment would be done when verification of software and mapping has been completed or if the equipment is smoking.

V-Gate 4000 Gateway

The Gateway 241 provides access from the SDVGS Node to the GSDS Network 120-1 via ISDN PRIs 245, the H320 side of the service. The V-Gate 4000 Gateway is the most duplicated piece of hardware in the Node 140. At this time, capacity of one V-Gate 4000 is two T1s but this capacity is being increased in the near future by the manufacturer.

Physical replacement of this piece of equipment when failed may only require a cable change or changing cards. Maintenance M&Ps should describe the process to perform this activity.

Recommendation is to have a spare, fully equipped V-Gate 4000 Gateway and spare cards available with a reasonable inventory. Possibly one spare unit for every 10 in service, two spares for every 25, 3 spares for every 75, etc. (Only three gateways 241 are shown in FIG. 2).

V-Gate 4000 Gatekeeper

The Gatekeeper 240 provides direction for the several Gateways 241. The Gatekeeper 240 stores and translates IP address and associated 700 number tables for registered subscribers. This piece of equipment may be a little more important than others. There is only one GK 240 per Node 140. The Gatekeeper 240 is designed to be modular in design and has cards and hard drives that can be replaced to restore service.

Recommendation is to have a spare, fully equipped V-Gate 4000 Gatekeeper and spare cards and hard drives available with a reasonable inventory. Further insurance would be to have a second HOT standby Gatekeeper that can be switched into service whenever an event requiring same occurs.

Redback Router

The router 205 provides the contexts used by all customers, routes IP customers to the Gatekeeper 240, to the Gateway 241, and then to the GSDS Network 120-1. Again there is only one; we conclude that it is very important to have a standby on hand.

Our recommendation is to have a spare, fully equipped Redback Router and spare cards and hard drives available with a reasonable inventory. Further insurance would be to have a second HOT standby Redback Router that can be switched when an event occurs.

Cabletron Hub

Fast switch 232 connects all Node 140 equipment at 10-100 Mbps. Duplication of this equipment is only part of the restoration concern. The recording of the connections on the Cabletron Hub needs to be accurate to restore service correctly. The Cabletron Hub failure characteristics need to be observed to better understand what needs to be done for disaster recovery.

Polycom Unit

Video units such, as the Polycom, are used to simulate H320 and H323 calls for normal daily testing. The GSDSNCC is equipped with much of this equipment, redundancy is a toss up here.

Ascend Max 4000

Used for remote maintenance access from Wide Area Network users. Here is how the Duffy District can remotely test the Node, a spare is probably required if failure characteristics are poor for this equipment.

Maintenance As Opposed To Disaster Recovery

A disaster is a deficiency that effects all customers or a large segment or area. Individual troubles are maintenance problems and need to be addressed normally.

After a sectionalization of a trouble to a specific service, such as ATM or Frame Relay Networks, ISDN PRI or FG-d TSG troubles to the LNS switch, the normal procedures will be taken to have the trouble referred to the appropriate organization or work center. A new escalation procedure may need to be established to provide more emphasis to a total service effecting incident.

The work center responsible for SDVGS, the GISDNNCC in Chicago, is the first group to identify a possible disaster. The GISDNNCC will be receiving customer notification by the method of trouble reports directly from either GISDN or SDVGS Customers. It should be evident that more troubles than normal are being received and should indicate a possible disaster waiting to happen.

Other methods for identifying a disaster are alarms in NODE equipment bays. Audible and visual alarm located at the equipment bay and in the GSDSNCC work area. The GSDSNCC is manned 7×24. The bays were the Node equipment resides is probably not manned. Alarms should be routined or checked regularly.

Other relevant work centers, such as ATM and Frame Relay, ISDN and LNS work center, would not normally notify the GSDSNCC of any major failures pertaining to the SDVGS service. As mentioned before, the amount of tickets received by the SDVGS work center will flag the technician to an event out of the normal.

Thus there has been shown and described a switched digital video gateway for processing calls between H.320 and H.323 networks and a router for securely processing H.323 video calls. The invention should only be deemed to be limited in scope by the claims that follow.

Glossary/Acronymns

2B1Q The binary coded signaling scheme used over a local copper-loop is called 2-Binary, 1-Quatemary (2B1Q). This is a four-level line-coding scheme. The first bit represents the polarity and second-bit is the magnitude. In 2B1Q line-coding scheme the signal transmission frequency is one-quarter of the bit rate frequency. The result is a transmission frequency of 196 Khz (786 Khz divided by four) on a pair of copper-wire. Because 2B1Q is not DC balanced an algorithm is used to scramble the bit streams to avoid excess DC bias on the transmission lines. The lowered signal transmission bit-rate at a frequency of 196 Khz, consumes less power on copper-path ensuring higher power availability for transmission of data-bits. 2B1Q line-coding also ensures symmetric (uniform) band-width availability for data transmission.

4ESS™ Number 4 Electronic Switching System

AAL ATM Adaptation Layer

IMA Inverse Multiplexer Arrangement, puts several T1s into one port

ANS AT&T Network Services

ASN AT&T Switched Network

ATM Asynchronous Transfer Mode

Available Bit Rate (ABR) This is a service category with a minimum usable bandwidth guarantee. Adding of additional bandwidth depends on the state of the network congestion. This category is usually used on LAN to LAN inter-connections.

B8ZS Binary (Bipolar) 8-zero substitution; A Line-code type, used on T1 and E1 circuits, in which a special code is substituted whenever 8 consecutive zeros are sent over the link. This code is then interpreted at the remote end of the connection.

Call-Bridging; In telecommunications networks bridging is a method of connecting one Local Area Network (LAN) to another Local Area Network (LAN) that uses the same protocol over Ethernet to achieve seamless call-flow. Some “intelligent bridges” learn which addresses are on what network and develop a learning table, so that, subsequent messages can be forwarded to the right network. In general all bridging occurs at the data-link-layer (OSI layer-2). Bridging is accomplished by copying of a data-frame from one network to the next network along the communications path. Bridging is also a method of path selection (as opposed to routing to a specified node). In bridged-networks no correspondence is required between addresses and paths. Put another way, in bridged networks, addresses do not imply anything about where hosts are physically attached to the network or even located on the network. Any address can appear at any location (in contrast with this, routing requires more thoughtful physical placement of hosts & nodes). Bridging heavily relies on “broadcasting”. Since a packet may contain no information other than the destination address, and, “gives no-clues on how the path to the destination should be selected”, the only option is to “send the packet everywhere” by “broadcast”. Bridging can therefore be very inefficient for large networks, but, can work in small networks, say, between adjacent LANs. Large networks such as WANs are rarely bridged. Bridging is commonly used to separate high-traffic areas of a LAN from low traffic areas. It works best with multiple servers, each with a “distinct clientele” that communicate only with a “home-node or root” for all communications. Transparent bridging, the type used in Ethernet and documented in IEEE 802.1 is based on the concept of a spanning-tree. This is a tree of Ethernet links and bridges, spanning the entire bridged network, but, the tree originates at a “root”, or “home-node” which can be determined by “election”. In IP transport the entire spanning tree is regarded a single link. In Ethernet-bridging, all decisions are based on the 48-bit Ethernet Address.

BRI; Basic Rate Interface [2-Bearer (2B) channels to carry user-data-packets and 1-D channel to carry signaling &/or diagnostics-information-packets. A copper-pair facility with 2B+1D channel interface between a user-equipment (CPE) and a network-interface or device.

B-Channel; Carries user service information including, digital data, video and voice associated packets.

Broadband Bearer Capacity Link; A rate associated link-request from the network such as CBR-link or VBR-link, Point-to-Point-Link or Point-to-Multi-point Link

Brouter; A Brouter is a network-bridge with combined router-functions

Connection-Oriented-Service: An end-to-end connection is signaled and established prior to data transmission. Classical IP over ATM using AAL5 is an example of a connection-oriented service.

Connectionless Service: Service where no end-to-end connection is established; Instead all data is sent over a Virtual Channel (VC)-to-a connection-less server. The connection-less server subsequently, establishes a connection to the destination. Switched Multi-megabit Data Service (SMDS) and Connectionless Broad Band Data Service (CBDS) over AAL3 or AAL4 are two examples of this type of service.

CBR; Constant Bit Rate. This class of service is typically used for applications that are delay and jitter sensitive and require a static amount of bandwidth available for the lifetime of the connection. Traffic using this class of service will be given the highest priority by the servicing algorithm of the equipment. Voice and circuit emulation would be examples of traffic that would use this service category. Video and Switched-Data could also use this service category since this category emulates a two point private line service.

CI Connection Identifier. Identifies the ATM connection and gives the VPI and VCI-values.

CNRDB Common Network Routing Data Base

(Identifies valid “NPA-NXX” needed to route DSA calls in “domain-82” & 4ESS switching-node)

CPN Calling Party Number

CO Central Office

CPE Customer Premises Equipment

CS Convergence Sub-layer; The sub-layer of the ATM Adaptation Layer (AAL) where traffic is adapted based on its type before undergoing segmentation into cells.

CTD Cell Transfer Delay; Average transit delay of cells across a VCC or VPC.

D-Channel Carries signals and data &/or diagnostics packets between the user and the network.

DCE Data Channel Equipment (generally the network end of a circuit)

DCME Digital Circuit Multiplication Equipment

DMS 100 (NIS S208-6 Issue 1.1 1992-08)

This variant represents Northern Telecom's implementation of National ISDN-1. It provides ISDN BRI user-network interfaces between the Northern Telecom ISDN. DMS-100 switch and terminals designed for the BRI DSL. It is based on CCITT ISDN-1, and, Q-series recommendations and the ISDN Basic Interface Call Control Switching, and, Signaling requirements & supplementary service Tech References published by Bellcore

DNS; Domain Name Server; It provides name to an IP Address translation. Software that lets users locate computers on the Internet by domain-names. The DNS server maintains a database of domain names (or host names) and their corresponding IP-Address. In this hypothetical example, if WWW.mycompany were presented to a DNS server, the IP address 204.0.8.51 would be returned.

Domain; Usually the last two words of a machine's hostname; In WWW.mycompany.com; mycompany.com is the Domain.

DPNSS1 (BTNR 188 1995-01)

Digital Private Network Signaling System No.1 is a common-channel signaling system used in Great Britain.

DSA Digital Switched Access (normally refers to Switched Access provided by LECs for customers provisioned by the LECs, e.g. BRI access or DSL-access provisioned by LECs over which LEC-customers can access AT&T network via Equal-Access Feature Group D (FGD) trunks between LEC Class-5 Central Office (LEC-CO) and an AT&T Central Office (CO) or Point of Presence (POP) supporting DSA.

DS-0 Digital Signal Level 0: 64 Kbps level of North American Digital Hierarchy.

DS-1 Digital Signal Level 1: 1.544 Mbps level of North American Digital Hierarchy, supporting 24 DS-0 signals. Also referred to as T-1.

DS-3 Digital Signal Level 3: 44.736 Mbps level of North American Digital Hierarchy, supporting 28DS-1 signals. Also referred to as T-3.

DTE Data Terminal Equipment; Equipment at the customer end of a circuit. {The network end of a circuit is generally called the DCE}.

Encapsulation; One type of transfer of IP data-grams (in UDP protocols) using condensed or compressed data within a ATM-cell (data packed within cells in “capsules” within a cell). Network elements (viz., bridge, router) should be able to recognize such encapsulated protocols in the ATM Adaptation Layer (AAL) used through the VPI/VCI identifiers used in directional transport of data.

ESF Extended Super-Frame Framing; an enhanced T1 format that allows a line to be monitored during normal operation. It uses 24-frames grouped together (instead of the 12-frame D4 super-frame) and provides room for CRC bits and other diagnostic commands.

Ethernet Address; Each system on an Ethernet network receives a copy of every transmission, even those addressed to other machines. However, only the system whose address is specified in the destination field of the packet will retail the received packet, ignoring those packets intended for other systems. An Ethernet address can also recognize two other types of addresses: Broadcast-address—which is reserved for sending to all stations on the network, simultaneously, and, Multicast-address—which is a limited form of broadcasting to a “subset of the systems on the Ethernet”. Each Ethernet Network Interface Card (NIC) is assigned a 48-bit integer known as its “Ethernet Address” or its “physical address”. This code is one way to distinguish computers attached to an Ethernet network.

Ethernet Network Interface Cards

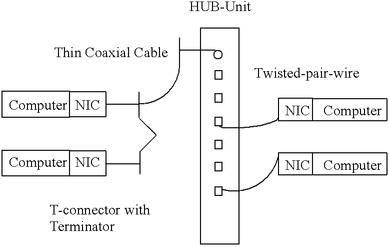

FR; Frame Relay—A high-speed packet switching protocol used in the wide are networks (WANs). It has become popular for LAN to LAN connections across remote distances, and, all the major carriers provide FR services. FR provides for a granular service up to DS3 rates of 44.736 Mbps and is suited for data and image transfer. Because of its variable-length packet architecture, it is not the most efficient technology for Real-Time voice and/or Video (but, good for real-time data (content-transport).

Gatekeeper; The Gatekeeper (GK) is an H.323 entity on the LAN that provides address translation and controls access to the Local Area Network for H.323 terminals, Gateways and MCUs. The Gatekeeper may also provide other services to the terminals, Gateways and MCUs such as “bandwidth management” and “locating Gateways”; [note: network endpoints are required to use a Gatekeeper; many don't]

Gateway; An H.323 Gateway (GW) is an endpoint on the Local Area Network, which provides for real-time, two-way communications between H.323 Terminals on the LAN and other ITU Terminals on a Wide Area Network (WAN), or to another H.323 Gateway. Other ITU Terminals include those complying with Recommendations H.310 (H.320 on B-ISDN), H.320 (ISDN), H.321 (ATM). H.322 (GQOS-LAN), H.324 (GSTN), H.324M (Mobile). And, V.70 (DSVD).

GSDS; Global Switched Digital Services

H.323; An umbrella (generic) recommendation from the International Telecommunications Union (ITU) that sets standards for multimedia communications over Local Area Networks (LANs) that do not provide a guaranteed Quality of Service (QoS). Such networks dominate to-day's corporate desktops and include packet switched TCP/IP and IPX over Ethernet, Fast Ethernet and Token Ring network topologies. H.323 umbrella and associated H.321/H.323-QoS supported terminal equipment requirements are important building blocks in defining systems that must work together to assure end-to-end transmission of video-calls over LANs.

H.323/H.321-Terminal is a specific endpoint on the Local Area Network which provides for real-time, two-way communications with another H.323 terminal, Gateway, or Multi-point Control Unit (MCU). This communication consists of control, indications, audio, moving color video pictures, and/or data between the two terminals. An H.323-QoS supported terminal may provide speech only, speech and data, speech and video, or speech, data and video.

H.320-Terminal ISDN D-channel uses a Data Link Layer protocol called Link Access Procedure in D (LAPD) which is based on out-of-band message signalling. This point-to-point protocol uses CSMA/Collision Resolution, which supports multiple H.320 enabled terminal equipment (devices) on the S/T bus.

H.323/H.321-InterWorking (Layer-1 to Layer-3)

H.323 QoS supported video applications often require bonding together of multiple B-channels to provide enhanced video quality. The primary gateway element V-Gate 4000 selected for SDVGS provides BONDING Mode-1 IMUX support in three levels: up to 384 Kbps (6×64 Kpbs) for calls over IP; up to 1472 Kpbs over ATM in T1 connections, and up to 1920 Kpbs over ATM in E1 connections. This allows the business video quality data-rates of 384 Kpbs to be utilized effectively without the additional hardware required in typical ISDN installations.

In network-access via xDSL, 2B1Q line coding used with SDSL-access assures uniform access bandwidth of up to 1-Mbps. 2B1Q coded SDSL-access lines are most suited for interactive video applications. A Network Terminator 1 (NT1) device used for ISDN-interface having four wire systems (at CPE-end) can be mated with SDSL 2-wire systems (at DSL client-end). Network Terminator 1 (NT1) device contains the S/T and U Reference points for services entering the NT1. Physically each of these reference points is a bus-interface. For example the S/T-bus is a four-wire bus that connects the NT1 to ISDN devices such as Terminal Equipment or Adapters. Each connection is assigned a Terminal Equipment Identifier (TEI) which in turn is associated with the service profile identifiers (SPIDs) for ISDN-access.

Front-end video-equipment and conferencing systems to be used in SDVG service delivery must comply with H.320, H.323 &/or H.321 specifications issued by the ITU-T. [Note: H.321 recommendation defines the technical specification for adapting narrow-band audio-visual communications terminals. Such terminals should also meet requirements of ATM Adaptation Layer-1 (AAL-1) for Constant Bit Rate (CBR).]

To assist in monitoring of QoS for calls switched between LANs and WANs the ITU-T issued H.323-QoS standards. Compliance to H.323-QoS standards is to assure use of H.320 &/or H.321 compliant front-end video-equipment via LAN-gateways and Wide Area Network (WAN) gateways. To support backward compatibility for existing network applications switched over a ATM switch, LAN Emulation (LANE) protocol is used. Using LANE, Ethernet transmitted information-packets can be mapped seamlessly onto ATM-based point-to-point Switched Virtual Circuits (SVCs). To cater to point-to-multi-point switching over ATM, Ethernet-broadcast and multicast modes are used. Since LANE operates as a protocol below the existing Ethernet-based-MAC-layer, all video-applications work transparently over ATM-networks as well as Ethernet-networks.

H.320/H.323/H.32I-InterWorking (Vendor Systems)—Switched Digital Video Gateway (SDVG) system under verification in this TP is the V-Gate 4000 system developed by First Virtual Corporation (FVC). V-Gate 4000 builds IP-interconnectivity onto the base of the earlier H.320/H.321 compatible V-Gate systems. The V-Gate 4000 system provides reliable data translation [using in-built and powerful H.323 Gate Keeper (GK) functionality] and network connectivity services between all three of the ISDN (H.320), ATM (H.321) and IP (H.323) environments. It can support up to 12 simultaneous videoconference translations between the H.320/H.321 and the H.323 environment. This is based on the integration of dedicated NICs for ISDN and ATM network environments as well as the use of one or more high performance digital signal processors (DSP)

The V-Gate 4000 system has in built Gate-Keeper (GK) functions to manage H.323 video calls. Gate-Keeper manages H.323 video-requests from several zones (collection of terminals, gateways, and Multi-point Conference Units (MCUs) by acting as the central control point for all calls within, and, registers all calls directed towards any end-point (call terminating point). Gate Keeper functions are vital to managing traffic in terms of bandwidth and provide control of number and type of connections, and, services vital to admission of a video-call to corporate networks. Gate Keeper functions include: Address Translation (look-up table maintenance), Admission Control (access-based priority, application based bandwidth, or other criteria), Bandwidth control (range definition) and Zone Management (by list administration). Gate Keepers can also support Call Signaling, Call Authorization, and, Call Management. The cumulative effect is to provide sub-net-level control to calls from several entities (terminals, gateways, and MCUs).

Video Switching system presently in verification as a Network Layer (Layer-3) switch is the “V-Switch”. This system developed by First Virtual Corporation (FVC), is a flexible ATM-switching system designed for Video networking, and, ATM-switching at speeds of 155 Mb/s, 25 Mb/s, and, T1 speeds. FVC's V-Switch is in testing to verify its integration and support capabilities for video-optimized Ethernet-frame-switching between H.320 compliant devices. Of particular interest under this TP are, a) V-Switch's ability to provide connectivity over “IP-Router & Ethernet-links” to H.321 compliant devices and b) ATM25 workgroup connections and video-conferencing capability over H.323 enabled devices [see http://www.FVC.com].

To assure interoperability of certain H.321 compliant devices, such as, “Picture Tel, First Virtual Corporation (FVC) also offers a “V-Room” system. V-Room eliminates the need to pull ISDN lines to each & every room system to be connected. V-Room permits plug-and-play operation without the need for complex IMUX re-configuration. This “V-Room” system is also under laboratory verification to test interoperability between compliant front-end equipment and H.321 enabled network devices deployed between call-origination and call-termination points.

RADVision's Gateway (GW) system under verification (as alternate to FVC.com GW) is model: L2W-323/P/8X gateway. This system is a LAN/WAN H.320 to H.323 Gateway and includes: 1 Ethernet LAN port, 1 PRI (11 @ 128 bps video conferencing calls; 16 @ voice-calls only); echo-cancellation, 8-Xcoder Ports (G.711 to G.723 or G.728); Built in Gatekeeper (GK.)

RADVision's MCU system under verification is model: MCU-323/15 (15 port H.323 MCU) that supports 15 sessions @128 k, 9 sessions @ 384 k, 7 sessions @ 768 k, 3 sessions @ 1.5M, 18 voice-sessions; Built in Gatekeeper (GK.)

H.323/H.321—linkage—An important link between the V-Switch and ATM network is the ATM-25 (IMA) Router system. The OEM Router System under verification for the “router functions” is Redback-Router SMS 500. The system under verification has four ports, provides ATM T1I/O for full-duplex 1.544 Mbps ATM connectivity on each of its four ports. The four ports use an ATM Segmentation And Re-assembly (SAR) device. The SAR is connected to the back-plane and forwards AAL5 data packets from the Front End (FE) process and assists with the inverse multi-plexer functions.

H-Channel—Performs the same function as B-Channels, but operates at rates exceeding DS-0 (64 Kbps)

HEC Header Error Control, A one-byte within the ATM cell header providing for Error detection. If an error is detected the ATM-cell is discarded before undergoing re-assembly.

IE Information Elements (e.g.: Cause, Call State, Endpoint Reference, AAL parameters, Connection Identifier, Quality of Service (QoS), Broadband Bearer Capacity etc . . . )

IMA Inverse Multi-plexer Arrangement, a router-card that can aggregate several T-1s into one ATM-port.

IP Address Internet Protocol Address. The physical address of a computer attached to a TCP/IP network. Every client and server station must have a unique IP Address. Client workstations have either a permanent address or one that is dynamically assigned for each dial-up session (see DNS.)

Internet IP-Address consists of two parts: a network-part and a host-part. Internet Addresses are 32-bit long and consist of four integers (representing bytes), each separated by a dot (.) Each of the four integer bytes is in the range of 0 to 255. Each byte can be represented in decimal, octal (begins with 0) or hexadecimal (begins with 0x or OX]. Network Class Types are: A, B, C and D.

IP-Address Class Types

| | | Class B | Class C | Class D |
|---|---|---|---|---|
| | Class A | >=128 | >191 | >233 |
| First Byte | <128 | And <=191 | and <=233 | and <255 |
| Byte(s) for | First byte (resrv) | First two | First three | First three |
| Network | | | | |
| Byte(s) for | Last three bytes | Last two | Last | Last |
| Hosts | | | | |

Internet IP-Address—consists of two parts: a network-part and a host-part. Internet Addresses are 32-bit long and consist of four integers (representing bytes), each separated by a dot (.) Each of four integer bytes is in the range of 0 to 255. Each byte can be represented in decimal, octal (begins with 0) or hexadecimal (begins with 0x or OX]

IPX Inter-network Packet Exchange. A NetWare communications protocol used to route messages from one node to another. IPX packets include network addresses and can be routed from one network to another. IPX provides services at layers-3 and 4 of the OSI models (also, see SPX)

ISUP Integrated Services User Part

ISDN Integrated Services Digital Network

ITU-T International Telecommunications Union—Telecommunications

LAN Local Area Network

LAP-D Link Access Protocol on the D-channel. LAP-D is a bit-oriented protocol at the data link layer (layer-2) of OSI reference model. Its prime function is ensuring the error free transmission of bits on the physical layer. LAPD works in the Asynchronous Balanced Mode (ABM). This mode is totally balanced (i.e., no master/slave relationship) where each station may initialize, supervise, recover from errors, and send frames at any time. This protocol treats DTE and DCE as equals.

LEC Local Exchange Carrier

LE Local Exchange—ISDN Central Office (CO) {LE implements the ISDN protocol for BRI}

MCU Multi-point Control Unit (MCU) is an endpoint on the Local Area Network which provides the capability for three or more terminals, and Gateway to participate in a multipoint conference. It may also connect two terminals in a point-to-point conference, which may later develop into a multi-point conference. The MCU generally operates in the fashion of an H.231 MCU, however, an audio processor is not mandatory. The MCU consists of two parts: a mandatory Multi-point Controller and optional Multi-point Processors. In its simplest case, an MCU may consist only of a Multi-point Controller (MC) with no Multi-point Processors (MPs).

Multi-point Controller—The Multi-point Controller (MC) is an H.323 entity on the Local Area Network, which provides for the control of three or more terminals participating in a multi-point conference. May also connect two terminals in a point-to-point conference, which may later develop into a multi-point conference. The MC provides for capability negotiation with all terminals to achieve common levels of communications. It also may control conference resources such as “who is multicasting the video”. The MC does not perform mixing of audio, video and data.

Multi-point Processor—The Multi-point Processor (MP) is an H.323 entity on the Local Area Network (LAN) which provides for the centralized processing of audio, video, and/or data streams in a multi-point conference. The MP provides for the mixing, switching, or other processing of media streams under the control of the MC. The MP may process a single media stream or multiple media streams depending on the type of conference supported.

MPEG Motion Picture Experts Group

MPEG-1 A Video Standard to ISO/IEC IS 11172-2

MPEG-2 A generic method for compressed representation of video and audio sequences using a common coding syntax defined in the document ISO/IEC 13818 by the International Organization for Standardization. The MPEG-2 video standard specifies the coded bit-stream for high-quality digital videos. As a compatible extension, MPEG-2 video builds on the completed MPEG-1 video standard (ISO/IEC IS 11172-2) by supporting interlaced video formating and a number of other advanced features, including support for applications such as Direct Broadcast Satellite, Cable Television, and, HDTV.

The ability of ATM to support voice, video and data simultaneously makes it an excellent candidate for MPEG implementations. In December 1995, the ATM forum issued the Video-on-Demand (V-o-D) Specification 1.0, which specifies the implementation of MPEG-2 over ATM. This implementation support the transport stream MPEG coding, using AAL5 for user data and the signaling 4.0 stack for call control.

Multiplexing—One of the most basic principles involved in sharing a single data link among multiple sessions. Transmitting multiple signals over a single communications line or computer channel. The two common multiplexing techniques are Frequency Division Multiplexing (FDM) which separates signals by modulating the data onto different carrier-frequencies, and, Time Division Multiplexing (TDM) which separates signals by interleaving bits one after another.

M24—Refers to the hardware and channels of a T1 line homed to CPE. There are 24-channels and each channel is 64K. One can split up the channels for different tasks; example 12-channels to maintain 2-simulataneous 384-video video sessions; 12 channels for voice-only, etc.

NANP—North American Numbering Plan (a 10-digit numbering plan of type NPA-NXX-TTTT)

NANPN North American Numbering Plan (compliant) Number

NT1 Termination of the connection between the User-site and LE; NT1 is responsible for Performance, Monitoring, Power Transfer, and, Multiplexing of the Channels.

NT2 May be any device that is responsible for providing User-site switching, multiplexing and Concentration, viz., LANs, Mainframe computers, terminal controllers, etc. In ISDN residential environment there is no NT2.

Non Real-time Variable Bit Rate (NRT-VBR)—This service category is intended for applications which generate “bursty” traffic. Large statistical gains are possible. Frame-Relay (FR) traffic transported through an ATM core maps well to nrt-VBR.

NPA Numbering Plan Area

NPSR Network Product/Service Realization (process outlining Q-13 to Q-0 gates tailored to cut-over new nodal service products/services over AT&T backbone network)

OC-3 Services—Optical Connection Level-3 at 155 Mbps (examples: Fast-Ethernet (100 Mbps), FDDI (100 Mbps)

OSI Open Systems Interface; ITU-T reference model that contains-7-layers: physical, data-link, network, transport, session, presentation, application.

PRI Primary Rate Interface (23-B channels plus 1-D channels in the facility.

Q.931—An ISDN protocol with active call-states identified to indicate call-initiation, acknowledgement, and, end-to-end connection progress, as originally recommended by the 1988 Consultative Committee on International Telecommunications & Telegraph (CCITT). Examples of the stages (states) are: +0=null; +1=call initiated; +2=overlap sending; +3=outgoing call proceeding; +4=call present; +6=call present; +7=call received; +8=connect request; +9=incoming call requested; +10=active; +11=disconnect request; +12=disconnect indication; +15=suspend request; +17=resume request; +19=release request; etc.

In circuit switched calls, because several calls may co-exist simultaneously at a user-network-interface, and, each call may be in different state (stage of connection progress), the state of the interface itself cannot be ambiguously defined. Hence Q.931 standard adopted for all ISDN call setup &/or receive stations.

R A communication-reference-point between a non-ISDN compatible TE and a TA.

Real-time Variable Bit Rate (RT-VBR)—This category is intended for real-time applications with limited “bursty” traffic. It has similar performance characteristics as CBR with the possibility of achieving a slight statistical gain. An example of service that would use Rt-VBR is the transmission of MPEG compressed video. The application transmits complete frames periodically but is still delay sensitive. Can be used for high-speed video-streaming applications.

Router—A device that routes data packets from one Local Area Network (LAN) or Wide Area Network (WAN) to another. Routers see the network as network addresses and all the possible paths between them. They read the network address in each transmitted frame and make a decision on how to send it based on the most expedient route taking into account traffic-load, line-costs, speed, bad-lines etc. Routers work at the network layer (OSI layer-3), whereas, bridges and switches work at the data-link layer (OSI layer-2). Multi-protocol routers support several protocols such as IPX, TCP/IP etc. Routers often serve as internet-backbone. Because routers have to inspect the network—address in the protocol, they do more processing and add more overhead than a bridge or switch. An edge router can be a router that provides the interface with an ATM-network.

Routing Algorithm—An algorithm that determines the next network point to which a packet should be forwarded either “on the way to” or “as final destination”. The Router device in some cases a software-program in a computer determines the next point, which a packet should be forwarded towards its destination. The Router is connected to at least two networks and decides which way to send each information packet based on its current understanding of the “network-state”. A Router device can maintain a table of the available routes and their conditions and can use that information along with distance and cost algorithms to determine the best route for a given packet. Typically a packet may travel through a number of network points with routers before arriving at its destination.

S A communication-reference-link between the TE or TA and the NT equipment.

SAPI—Service Access Point Identifier, the first part of the address of each frame.

SDDN Software Defined Data Network

SDDN-I Software Defined Data Network-International p1 SDN Software Defined Network (voice services, dedicated VPN/Corporate networks)

SDS Switched Digital Services

SINA Static Integrated Network Access. Allows customer to integrate different services such as voice and data access line using a Multiplexer.

SINA2 Nodal only service; Thus, since Multiplexing functionality is necessary to support AT&T-IP services, SINA2 is not an option for AT&T Business IP Services.

SMS Service Management System

SNMP Simple Network Management Protocol; management protocol for the Operations, Administration, Maintenance & Provisioning (OAM&P) of inter-networks. SNMP was originally designed for TCP/IP, now extended to other functions.

SPX Sequenced Packet Exchange. The NetWare communications protocol used to control the transport of messages across a network. SPX ensures that an entire message arrives intact and uses NetWare's IPX protocol as its delivery mechanism. Application programs use SPX to provide client-server and peer-to-peer interaction between network nodes. SPX provides services at layer-4 of the OSI-model.

SVC Switched Virtual Circuit; A logical ATM connection established via signaling. {End-systems transmit their UNI 3.1 or UNI 4.0 signaling request via the Q.2931 signaling protocol}.

T A communication-reference-point between user switching equipment and a Local Loop Terminator

T-1/T1.5 A North American Physical transmission system consisting of two twisted wire pairs to support 1.544 Mbps transmission

TCP/IP Transmission Control Protocol/Internet Protocol. A communications protocol developed under contract from US-Dept., of Defense to inter-network dissimilar systems. It is a de-facto UNIX standard, but is now supported on almost all platforms. TCP/IP: is the protocol now of the commercial Internet. The TCP part of the TCP/IP provides transport protocol functions, ensuring that the total amount of bytes sent is received correctly at the other end. The IP part of the protocol provides the routing mechanism. TCP/IP is a routable protocol, which means that the messages transmitted contain the address of a destination within an organization or around the world, hence its use in the worldwide Internet. TCP/IP frames use a logical address of the destination station rather than a physical address. This logical IP address, which also includes the network address, is dynamically mapped to a physical station address (Ethernet, Token Ring, ATM etc) at runtime. TCP/IP includes a file transfer capability called FTP, or File Transfer Protocol which in-turn allows files to be downloaded and uploaded between TCP/IP sites.

TE Terminal Equipment—any user device, e.g.: telephone or facsimile machine.

TE1 Terminal Equipment is ISDN Compatible

TE2 Terminal Equipment is not ISDN Compatible.

TEI Terminal Endpoint Identifier; the identifier in the second part of the address of each frame.

TIU Terminal Interface Unit.

U A reference point between the NT equipment and the Local Exchange (LE). This reference point may be referred to as “network boundary” when FCC definition of the Network terminal is used.

UNI User Network Interface . . . for direct DS-1, DS-3, OC-3 links from a CPE to a ATM-switch.

UBR Unspecified Bit Rate. Also called “best effort service”. It has no imbedded QoS characteristics and takes advantage of the remaining bandwidth in a network. Applications such as e-mail and LAN inter-connect can use this service.

VBR Variable Bit Rate

VDSL Very High Speed Digital Subscriber Line

What we claim is:

1. Video gateway apparatus for interworking between an internet protocol video data network and an integrated services digital network comprising
a router operatively associated with said internet protocol video data network for outputting video and control data associated with a video call originating in said internet network,
at least one gateway switch coupled to said router and operatively associated with said integrated services digital network for outputting video and control data associated with a video call originating in said integrated services digital network, and
at least one gatekeeper operatively associated with said router and said at least one gateway switch for translating between video telephone numbers assigned within said integrated services digital network and internet protocol addresses associated with said internet protocol video data network.

2. Apparatus as recited in claim 1 further comprising a digital data hub coupled between said gatekeeper and said router.

3. Apparatus as recited in claim 1 wherein said gateway outputs a calling party number output of said gatekeeper to an integrated switched digital network via a primary rate interface.

4. Apparatus as recited in claim 1 wherein said router is operatively associated with an asynchronous transfer mode network via at least one permanent virtual circuit.

5. A method of processing a video call via video gateway apparatus originating in an internet protocol video data network for completion within an integrated services digital network comprising the steps of
receiving an address formatted as an internet address representing an integrated services digital network telephone number and
translating the address into video data routing data, said video gateway apparatus for delivering received packetized video data to a video capable telephone associated with said integrated services digital network telephone number.

6. The method of claim 5 further comprising the steps of
receiving a calling party address formatted as an internet address representing an alias directory telephone number,
translating said internet address into said alias directory telephone number and
transmitting said alias directory telephone number as a calling party telephone number by means of a primary rate interface into said integrated services digital network.

7. A method of processing a video call via video gateway apparatus originating in an integrated services digital network for completion within an internet protocol video data network comprising the steps of
receiving an address formatted as a local telephone number representing an internet address and
translating the received address into a destination internet address associated with said local telephone number, said video gateway routing video data associated with said call to said destination internet address.

8. A method of assuring security of a video call in an internet protocol video data network wherein a router communicates with a gatekeeper of said network in a control channel session characterized by the steps of
the router initiating a query of said gatekeeper to determine the status of said control channel session and
the router precluding a delivery of video data to a destination address if said query is negative or
the router delivering video data to a destination address if said query is positive.

9. The method of claim 8 wherein so long as said router periodically receives a positive query response, said router delivers video data.

10. The method of claim 8 wherein said router buffers a terminating video call until said router receives a positive query response.
